(19) United States
(12) Patent Application Publication
(10) Pub. No.: US 2021/0286277 A1
(43) Pub. Date: Sep. 16, 2021

(54) UNDERCOAT LAYER, METHOD FOR MANUFACTURING UNDERCOAT LAYER, ELECTROPHOTOGRAPHIC PHOTORECEPTOR, AND IMAGE FORMING APPARATUS

(71) Applicant: KYOCERA Document Solutions Inc., Osaka-shi (JP)

(72) Inventor: Tomofumi SHIMIZU, Osaka-shi (JP)

(21) Appl. No.: 17/199,561

(22) Filed: Mar. 12, 2021

(30) Foreign Application Priority Data
Mar. 16, 2020 (JP) 2020-045210

(51) Int. Cl. G03G 5/14; G03G 5/05; G03G 5/06; G03G 15/00; G03G 21/00

(52) U.S. Cl. CPC G03G 5/144; G03G 5/056; G03G 5/0677; G03G 5/0668; G03G 21/0058; G03G 5/06145; G03G 5/0618; G03G 15/75; G03G 5/067

(57) ABSTRACT

The undercoat layer contains metal particles and a polyamide resin. The metal particle has a core and a coat layer covering at least a part of the core. The core contains titanium oxide. The coat layer contains at least a metal oxide different from titanium oxide. The metal oxide different from the titanium oxide is located on the outermost surface of the metal particles. The polyamide resin has an amide bond and an alkylene group. The absorption rate of the first peak derived from the amide bond to the second peak derived from the alkylene group to the first absorbance measured by infrared spectroscopy is ≥0.70.

### INCORPORATION BY REFERENCE

This application is based on and claims the benefit of Japanese Patent Application No. 2020-045210 filed on May 16, 2020, and the contents of which are hereby incorporated by reference.

### BACKGROUND

The present disclosure relates to a undercoat layer, a method of manufacturing the undercoat layer, an electrophotographic photoreceptor, and an image forming apparatus.

The electrophotographic photoreceptor is used as an image carrier in an electrophotographic image forming apparatus (e.g., printers or multifunction devices). The electrophotographic photoreceptor includes a conductive substrate and a photosensitive layer. In order to suppress the occurrence of leakage in the photosensitive layer, an undercoat layer may be provided between the conductive substrate and the photosensitive layer.

Such an electrophotographic photoreceptor has an undercoat layer between the conductive substrate and the photosensitive layer. The undercoat layer contains an organometallic compound and an inorganic pigment.

### SUMMARY

The undercoat layer according to the present disclosure contains metal particles and a polyamide resin. The metal particles have a core and a coat layer covering at least a part of the core. The core contains titanium oxide. The coat layer contains at least a metal oxide different from the titanium oxide. The metal oxide different from the titanium oxide is located on the outermost surface of the metal particles. The polyamide resin has an amide bond and an alkylene group. The absorption rate of the second absorbance of the second peak derived from the alkylene group to the first absorbance of the first peak derived from the amide bond measured by infrared spectroscopy is ≥0.70. The first peak is the maximum peak in the wave number range of 1620 cm⁻¹ to 1680 cm⁻¹. The second peak is the maximum peak in the wave number range of 2900 cm⁻¹ to 2970 cm⁻¹.

A method according to the present disclosure for manufacturing a undercoat layer, comprising the step of forming the undercoat layer according to a first aspect, wherein the undercoat layer is formed by applying a coating liquid containing the metal particles, the polyamide resin, and a solvent to an object to be coated and drying the coating liquid.

The solvent contains methanol, butanol and toluene.

The percentage M_{M} of the mass of methanol, the percentage M_{B} of the mass of butanol, and the percentage M_{T} of the mass of toluene to the mass of the solvent satisfy the following formulae (2), (3), (4), and (5).

M_{M}+M_{B}+M_{T}=100 (2)

30≤M_{M}≤90 (3)

5<M_{B}<50 (4)

5≤M_{T}≤50 (5)

The electrophotographic photoreceptor according to the present disclosure includes a conductive substrate, a photosensitive layer containing a charge generating agent, and the aforementioned undercoat layer provided between the conductive substrate and the photosensitive layer.

### BRIEF DESCRIPTION OF THE DRAWINGS

FIG. 1 is a cross-sectional view of an example of metal particles contained in a undercoat layer according to a first embodiment of the present disclosure.

FIG. 2 is a cross-sectional view of an example of metal particles contained in a undercoat layer according to a first embodiment of the present disclosure.

FIG. 3 is a partial cross-sectional view of a single-layer electrophotographic photoreceptor as an example of an electrophotographic photoreceptor according to a third embodiment of the present disclosure.

FIG. 4 is a partial cross-sectional view of a single-layer electrophotographic photoreceptor as an example of an electrophotographic photoreceptor according to a third embodiment of the present disclosure.

FIG. 5 is a partial cross-sectional view of a layered electrophotographic photoreceptor as an example of an electrophotographic photoreceptor according to a third embodiment of the present disclosure.

FIG. 6 is a partial cross-sectional view of a layered electrophotographic photoreceptor as an example of an electrophotographic photoreceptor according to a third embodiment of the present disclosure.

FIG. 7 is a partial cross-sectional view of a layered electrophotographic photoreceptor which is an example of an electrophotographic photoreceptor according to a third embodiment of the present disclosure.

FIG. 8 is a cross-sectional view showing an example of an image forming apparatus according to a fourth embodiment of the present disclosure.

### DETAILED DESCRIPTION

Embodiments of the present disclosure will be described below, but the present disclosure is not limited to any embodiments, and may be implemented with appropriate modifications within the scope of the purpose of the present disclosure. In addition, although the description may be omitted in some cases, the gist of the disclosure is not limited. Unless otherwise specified, only one material may be used for each of the materials described in the embodiments of the present disclosure, and two or more materials may be used in combination. The term “independently of each other” used in the description of the general formula means “each being the same or different”. In some cases, the compound and its derivatives are collectively referred to by adding “system” after the compound name. When the name of the polymer is represented by adding “system” after the name of the compound, it means that the repeating unit of the polymer is derived from the compound or its derivative.

First, the substituents used herein will be described. The halogen atom (halogen group) includes, for example, a fluorine atom (fluoro group), a chlorine atom (chloro group), a bromine atom (bromo group), and an iodine atom (iodine group).

Each of an alkyl group having 1 to 8 carbon atoms, an alkyl group having 1 to 6 carbon atoms, an alkyl group having 1 to 4 carbon atoms, an alkyl group having 2 to 4 carbon atoms, an alkyl group having 1 to 3 carbon atoms, an alkyl group having 5 carbon atoms, and an alkyl group having 4 carbon atoms is linear or branched and unsubstituted unless otherwise specified. As the alkyl group having 1 to 8 carbon atoms, for example, methyl, ethyl, n-propyl, isopropyl, n-butyl, sec-butyl, tert-butyl, n-pentyl, 1-methylbutyl, 2-methylbutyl, 3-methylbutyl, 1-ethylpropyl, 2-ethylpropyl, 1,1-dimethylpropyl, 1,2-dimethylpropyl, 2,2-dimethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1,1,2trimethylpropyl, 1,2,2-trimethylpropyl, 1-ethylbutyl, 2-ethylbutyl and 3-ethylbutyl groups, linear and branched heptyl groups, and linear and branched octyl groups. Examples of an alkyl group having 1 to 6 carbon atoms, an alkyl group having 1 to 4 carbon atoms, an alkyl group having 2 to 4 carbon atoms, an alkyl group having 1 to 3 carbon atoms, an alkyl group having 5 carbon atoms, and an alkyl group having 4 carbon atoms are each a group having a corresponding number of carbon atoms among the groups described as examples of alkyl groups having 1 to 8 carbon atoms.

An alkoxy group having 1 to 8 carbon atoms, an alkoxy group having 1 to 6 carbon atoms, and an alkoxy group having 1 to 3 carbon atoms are linear or branched and unsubstituted, unless otherwise specified. Examples of the alkoxy group having 1 to 8 carbon atoms include methoxy group, ethoxy group, n-propoxy group, isopropoxy group, n-butoxy group, sec-butoxy group, tert-butoxy group, n-pentoxy group, 1-methylbutoxy group, 2-methylbutoxy group, 3-methylbutoxy group, 1-ethylpropoxy group, 2-ethylpropoxy group, 1,1-dimethylpropoxy group, 1,2-dimethylpropoxy group, 2,2-dimethylpropoxy group, n-hexyloxy group, 1-methylpentyloxy group, 2-methylpentyloxy group, 3-methylpentyloxy group, 4-methylpentyloxy group, 1,1-dimethylbutoxy group, 1,2-dimethylbutoxy group, 1,3-dimethylbutoxy group, 2,2-dimethylbutoxy, 2,3-dimethylbutoxy, 3,3-dimethylbutoxy, 1,1,2-trimethylpropoxy, 1,2,2-trimethylpropoxy, 1-ethylbutoxy, 2-ethylbutoxy, 3-ethylbutoxy, linear and branched heptyloxy, and linear and branched octyloxy groups. Examples of alkoxy groups having 1 to 6 carbon atoms and alkoxy groups having 1 to 3 carbon atoms are groups having a corresponding number of carbon atoms among the groups described as examples of alkoxy groups having 1 to 8 carbon atoms.

An aryl group having 6 to 14 carbon atoms and an aryl group having 6 to 10 carbon atoms are not substituted, unless otherwise specified. Examples of the aryl group having 6 to 14 carbon atoms include phenyl, naphthyl, indacenyl, biphenylenyl, acenaphthylenyl, anthryl, and phenanthryl. Examples of aryl groups having 6 to 10 carbon atoms include phenyl groups and naphthyl groups. The substituents used herein have been described above.

### First Embodiment: Undercoat Layer

A first embodiment of the present disclosure relates to a undercoat layer. The undercoat layer according to the first embodiment contains metal particles and a polyamide resin.

(Metal Particle)

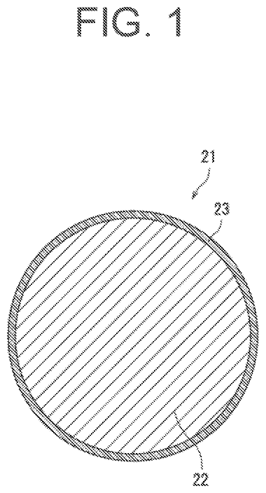

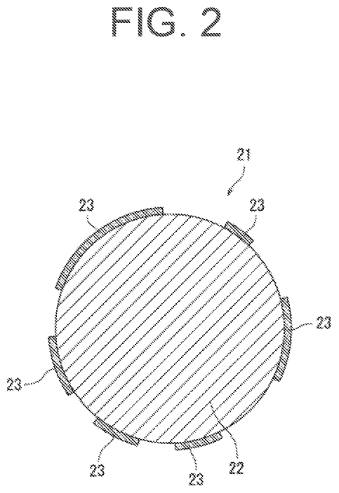

Referring to FIGS. 1 and 2, the structure of the metal particles 21 contained in the undercoat layer will be described below. The metal particles 21 shown in FIG. 1 have a core 22 and a coat layer 23. The coat layer 23 covers at least a portion of the surface of the core 22. The core 22 is, for example, particulate. As shown in FIG. 1, a coat layer 23 may be provided over the entire surface of the core 22. That is, the coat layer 23 may cover the entire surface of the core 22. Also, as shown in FIG. 2, the coat layer 23 may be provided on a portion of the surface of the core 22. That is, the coat layer 23 may cover a portion of the surface of the core 22. With reference to FIGS. 1 and 2, the structure of the metal particles 21 contained in the undercoat layer has been described.

The core of the metal particles contains titanium oxide. Since the core of the metal particles contains titanium oxide, when the undercoat layer is provided on the electrophotographic photoreceptor (hereinafter, it may be described as a photoreceptor), the pressure resistance of the photoreceptor can be improved. Here, the pressure resistance of the photoreceptor is such a characteristic that leakage hardly occurs in the photoreceptor even when a high voltage is applied to the photoreceptor. Since the core of the metal particles contains titanium oxide, the volume resistivity of the undercoat layer containing the metal particles is increased, and charge hardly flows in the undercoat layer. When an undercoat layer is provided between the photosensitive layer of the photoreceptor and the conductive substrate, the higher the volume resistivity of the undercoat layer is, the less charge is likely to flow from the photosensitive layer to the conductive substrate at once through the undercoat layer. As a result, even when a high voltage is applied to the photoreceptor, leakage hardly occurs in the photoreceptor, and the pressure resistance of the photoreceptor is improved.

The coat layer of the metal particles contains at least a metal oxide different from titanium oxide. Hereinafter, “Metal oxide different from titanium oxide contained in coat layer” may be referred to as a metal oxide for a coat layer. The metal oxide for the coat layer is located on the outermost surface of the metal particles (exist). The coat layer is, for example, an outermost surface layer of metal particles. Since the metal oxide for the coat layer is located on the outermost surface of the metal particles, when the photoreceptor is provided in the undercoat layer, the sensitivity characteristics of the photoreceptor are hardly changed by humidity.

The coat layer may be composed of a layered metal oxide for the coat layer. The coat layer may be composed of an aggregate of powdery metal oxides for the coat layer.

The metal oxide for the coat layer is preferably alumina or zirconia and more preferably alumina in order to suppress the fluctuation of the sensitivity characteristics of the photoreceptor due to humidity. The coat layer preferably further contains silica in addition to the metal oxide for the coat layer.

In order to suppress fluctuations in the sensitivity characteristics of the photoreceptor due to humidity, the coat layer preferably does not contain a polymer having a siloxane bond (More specifically, silicone oil, silicone resin, methyl hydrogen polysiloxane, etc.).

In order to improve the pressure resistance of the photoreceptor and suppress the fluctuation of the sensitivity characteristics of the photoreceptor due to humidity, the content of the metal particles is preferably 2.0 parts by mass or more, and more preferably 2.5 parts by mass or more, relative to 1.0 part by mass of the polyamide resin. In order to suppress the fluctuation of the sensitivity characteristics of the photoreceptor due to humidity, the content of the metal particles is preferably 10.0 parts by mass or less, more preferably 5.0 parts by mass or less, and still more preferably 3.0 parts by mass or less, relative to 1.0 part by mass of the polyamide resin.

The volume resistivity of the undercoat layer is preferably 1.0×10¹⁰ Ω·cm or more, and more preferably 3.0×10¹⁰ Ω·cm or more. In the case where the undercoat layer is provided between the photosensitive layer of the photoreceptor and the conductive substrate, if the volume resistivity of the undercoat layer is 1.0×10¹⁰ Ω·cm or more, it becomes difficult for electric charges to flow in at once from the photosensitive layer to the conductive substrate through the undercoat layer. As a result, even when a high voltage is applied to the photoreceptor, leakage hardly occurs in the photoreceptor, and the pressure resistance of the photoreceptor is improved. The upper limit of the volume resistivity of the undercoat layer is not particularly limited, but the volume resistivity of the undercoat layer is, for example, 1.0×10¹² Ω·cm or less. The volume resistivity of the undercoat layer is measured by the method described in the Examples.

(Polyamide Resin)

The polyamide resin contained in the undercoat layer has an amide bond and an alkylene group. The absorption rate (A₂/A₁) of the second absorbance (A₂) of the second peak derived from the alkylene group to the first absorbance (A₁) of the first peak derived from the amide bond measured by infrared spectroscopy is not less than 0.70. The first peak is the maximum peak in the wave number range of 1620 cm⁻¹ to 1680 cm⁻¹. The second peak is the maximum peak in the wave number range of 2900 cm to 2970 cm⁻¹.

Since the absorption rate (A₂/A₁) of the polyamide resin contained in the undercoat layer is 0.70 or more, when the undercoat layer is provided on the photoreceptor, fluctuation in sensitivity characteristics of the photoreceptor due to humidity can be suppressed. Generally, as the humidity decreases, the undercoat layer dries and the resistance of the undercoat layer increases, and the photoreceptor tends to be easily charged. Therefore, when the humidity fluctuates, the sensitivity characteristic of the photoreceptor also tends to fluctuate. Here, the amide bond (—CO—N<) has hydrophilicity. Long chain aliphatic groups such as alkylene groups (—CH₂—) are hydrophobic. If the absorption rate (A₂/A₁) of the second absorbance (A₂) of the second peak derived from the alkylene group to the first absorbance (A₁) of the first peak derived from the amide bond is not less than 0.70, the hydrophobic alkylene group of the polyamide resin is appropriately increased to impart the proper hydrophobicity to the polyamide resin. The undercoat layer containing such a polyamide resin hardly absorbs moisture even in a high humidity environment, and the resistance of the undercoat layer is hardly changed by humidity. As a result, when such a undercoat layer is provided on the photoreceptor, it is possible to suppress fluctuation of sensitivity characteristics of the photoreceptor due to humidity.

In order to suppress the fluctuation of the sensitivity characteristic of the photoreceptor due to humidity, the absorption rate (A₂/A₁) of the polyamide resin is preferably 0.75 or more, more preferably 0.80 or more, still more preferably 1.00 or more, still more preferably 1.30 or more. The upper limit of the absorption rate (A₂/A₁) of the polyamide resin is not particularly limited, but the absorption rate (A₂/A₁) of the polyamide resin is, for example, 2.00 or less.

The absorption rate (A₂/A₁) of the polyamide resin is measured by the KBr (potassium bromide) tablet method using a Fourier transform infrared spectrophotometer. The first peak is, for example, a peak having a wave number of 1640 cm⁻¹. The second peak is, for example, a peak having a wave number of 2920 cm⁻¹. The method for measuring the absorption rate (A₂/A₁) of the polyamide resin will be described in detail later in the Examples.

In order to suppress the fluctuation of the sensitivity characteristic of the photoreceptor due to humidity, the water absorption rate of the polyamide resin is preferably 3.0 mass % or less, more preferably 2.0 mass % or less, and still more preferably 1.0 mass % or less. The water absorption rate of the polyamide resin is, for example, ≥0.0 mass %. The water absorption of the polyamide resin is measured by the method described in the Examples.

In order to suppress the fluctuation of the sensitivity characteristic of the photoreceptor due to humidity, it is preferable that the first charging potential C_{HH} of the undercoat layer when a current of +10 μA is supplied to the undercoat layer under a first environment (hereinafter may be referred to as HH environment) at a temperature of 32.5° C. and a relative humidity of 80%, and the second charging potential C_{LL} of the undercoat layer when a current of +10 μA is supplied to the undercoat layer under a second environment (hereinafter may be referred to as LL environment) at a temperature of 10.0° C. and a relative humidity of 15% satisfy the following formula (1). The unit of relative humidity, %, is sometimes called % RH.

|C_{HH}−C_{LL}|≤10 V (1)

In the expression (1), |C_{HH}−C_{LL}| denotes an absolute value of a value calculated from the expression “C_{HH}−C_{LL}”. Hereinafter, a value calculated from |C_{HH}−C_{LL}| in expression (1) may be described as a charge potential difference. For example, the first charging potential C_{HH} and the second charging potential C_{LL} are both positive values.

In order to suppress the fluctuation of the sensitivity characteristic of the photoreceptor due to humidity, the charge potential difference of the undercoat layer is preferably 7 V or less, and more preferably 5 V or less. The charging potential difference of the undercoat layer is, for example, 0 V or more. The charge potential difference of the undercoat layer is measured by the method described in the Examples.

The undercoat layer may further contain a resin other than the polyamide resin. The undercoat layer may further contain other inorganic particles (For example, aluminum particles, iron particles, copper particles, tin oxide particles, or zinc oxide particles) in addition to the metal particles. The undercoat layer may contain only metal particles and polyamide resin, and may further contain an additive.

### Second Embodiment: Method of Manufacturing a Undercoat Layer

A second embodiment of the present disclosure relates to a method of manufacturing a undercoat layer. The method of manufacturing the undercoat layer according to the second embodiment includes a step of forming the undercoat layer. In the undercoat layer forming step, a coating liquid (hereinafter, it may be referred to as coating liquid for undercoat layer) is applied to the object to be coated and dried to form the undercoat layer according to the first embodiment. The object to be coated is, for example, a conductive substrate described later in the third embodiment. The coating liquid contains the metal particles described in the first embodiment, the polyamide resin described in the first embodiment, and a solvent.

The solvent contained in the coating liquid for the undercoat layer contains methanol, butanol and toluene. The percentage of the mass of methanol M_{M} to the mass of the solvent, percentage of the mass of butanol M_{B} to the mass of solvent and the percentage M_{T} of the mass of toluene to the mass of solvent satisfy the following formulae (2), (3), (4) and (5). By using such a solvent, the undercoat layer in which the metal particles are suitably dispersed in the polyamide resin can be manufactured, and when the undercoat layer is provided on the photoreceptor, the pressure resistance of the photoreceptor can be improved, and the fluctuation of the sensitivity characteristic of the photoreceptor due to humidity can be suppressed.

M_{M}+M_{B}+M_{T}=100 (2)

30≤M_{M}≤90 (3).

5<M_{B}<50 (4)

5≤M_{T}≤50 (5).

The coating liquid for the undercoat layer is prepared by dispersing each component in a solvent. Dispersion can be, for example, a rod sonic oscillator, a bead mill, a roll mill, a ball mill, an attritor, a paint shaker, or an ultrasonic disperser.

A developing system provided with a plurality of developing devices 3a to 3d filled with the same color and the same type of toner (Here we have four) is effective when an image having a high printing rate is frequently continued. When the printing ratio is high, a difference in image density tends to occur in the axial direction of the developing roller 31, so that it is difficult to reproduce the uniformity by any one developing device. Therefore, it is possible to reproduce the uniformity by superimposing the halftone images on a plurality of developing devices 3a to 3d. In some cases, by setting the developer conveying direction at the agitating portions of 2 of the 4 developing devices 3a to 3d (For example, developing devices 3a, 3d) in the opposite direction, the uniformity of the image in the axial direction of the developing roller 31 can be further improved.

Examples of the method of applying the coating liquid for the undercoat layer include a dip coating method, a spray coating method, a spin coating method, and a bar coating method.

In order to determine the stop or return of the image forming portions Pa to Pd as described above, it is necessary to detect which image forming portion Pa to Pd has an abnormality or whether the abnormality has been resolved. However, when an image is formed by using the image forming portions Pa to Pd including the developing devices 3a to 3d filled with the toner of the same color, occurrence or recovery of abnormality in the image forming portions Pa to Pd cannot be easily detected.

The method for drying the solvent contained in the coating liquid for the undercoat layer includes, for example, heating, decompression, or a combination of heating and decompression. More specifically, a method of heat treatment (hot air drying) using a high temperature dryer or a vacuum dryer is cited. The temperature of the heat treatment is, for example, 40° C. to 150° C. The heat treatment time is, for example, 3 to 120 minutes.

### Third Embodiment: Photoreceptor

A third embodiment of the present disclosure relates to a photoreceptor. The photoreceptor according to the third embodiment includes a conductive substrate, a photosensitive layer, and the undercoat layer described in the first embodiment. The undercoat layer is provided between the conductive substrate and the photosensitive layer. Since the photoreceptor has the undercoat layer according to the first embodiment, the photoreceptor according to the third embodiment is excellent in pressure resistance and can suppress fluctuation of sensitivity characteristics due to humidity for the same reason as described in the first embodiment.

Examples of the photoreceptor include a single-layer electrophotographic photoreceptor (hereinafter, it may be referred to as a single-layer photoreceptor) and a layered electrophotographic photoreceptor (hereinafter, it may be referred to as a layered photoreceptor).

(Single-Layer Photoreceptor)

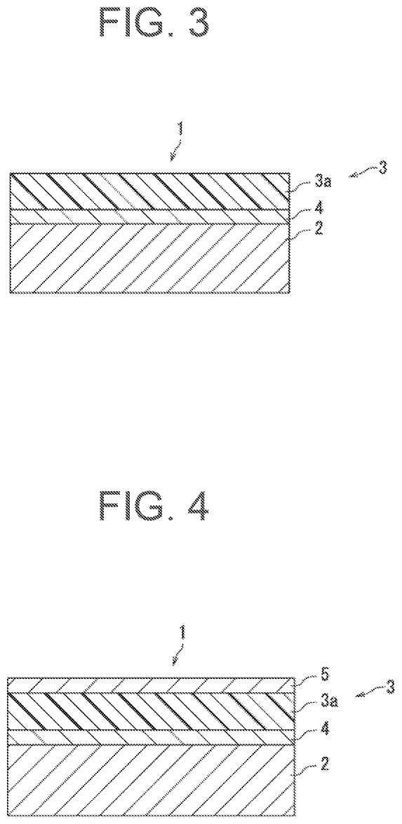

Referring to FIGS. 3 and 4, the single-layer photoreceptor 1 will be described below. FIGS. 3 and 4 are partial sectional views of a single-layer photoreceptor 1 as an example of the photoreceptor according to the third embodiment.

The single-layer photoreceptor 1 shown in FIG. 3 includes, for example, a conductive substrate 2, a single-layer photosensitive layer 3a, and an undercoat layer 4. The photosensitive layer 3 provided in the single-layer photoreceptor 1 is a single-layer photosensitive layer 3. Hereinafter, the single-layer photosensitive layer 3 may be referred to as a single-layer photosensitive layer 3a. The undercoat layer 4 is provided between the conductive substrate 2 and the single-layer photosensitive layer 3a. The undercoat layer 4 is the undercoat layer 4 according to the first embodiment.

As shown in FIG. 4, the single-layer photoreceptor 1 may further include a protective layer 5. The protective layer 5 is provided on the single-layer photosensitive layer 3a. As shown in FIG. 3, the single-layer photosensitive layer 3a may be provided as the outermost surface layer of the single-layer photoreceptor 1. Alternatively, as shown in FIG. 4, the protective layer 5 may be provided as the outermost surface layer of the single-layer photoreceptor 1.

The single-layer photosensitive layer 3a contains, for example, a charge generating agent, a hole transporting agent, an electron transporting agent, and a binder resin. The single-layer photosensitive layer 3a may further contain an additive if necessary. The thickness of the single-layer photosensitive layer 3 a is not particularly limited, but is preferably 5 μm or more and 100 μm or less, and more preferably 10 μm or more and 50 μm or less. The single-layer photoreceptor 1 has been described with reference to FIGS. 3 and 4.

(Layered Photoreceptor)

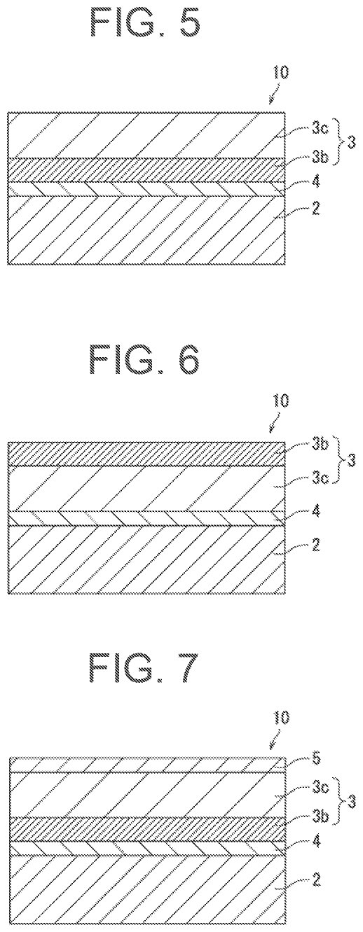

Next, referring to FIGS. 5 to 7, the layered photoreceptor 10 will be described. FIGS. 5 to 7 are partial cross-sectional views of a layered photoreceptor 10, which is an example of the photoreceptor according to the third embodiment.

The layered photoreceptor 10 shown in FIG. 5 includes, for example, a conductive substrate 2, a photosensitive layer 3, and an undercoat layer 4. The photosensitive layer 3 includes a charge generating layer 3a and a charge transport layer 3b. The charge generating layer 3b is, for example, one layer. The charge transport layer 3c is, for example, one layer. The undercoat layer 4 is provided between the conductive substrate 2 and the photosensitive layer 3. The undercoat layer 4 is the undercoat layer 4 according to the first embodiment.

As shown in FIG. 5, in the layered photoreceptor 10, the undercoat layer 4 may be provided on the conductive substrate 2, the charge generating layer 3 b may be provided on the undercoat layer 4, and the charge transport layer 3 c may be provided on the charge generating layer 3 b. Alternatively, as shown in FIG. 6, in the layered photoreceptor 10, the undercoat layer 4 may be provided on the conductive substrate 2, the charge transport layer 3 c may be provided on the undercoat layer 4, and the charge generating layer 3 b may be provided on the charge transport layer 3 c.

As shown in FIG. 7, the layered photoreceptor 10 may further include a protective layer 5. The protective layer 5 is provided on the photosensitive layer 3. As shown in FIGS. 5 and 6, the photosensitive layer 3 (For example, the charge transport layer 3b or the charge generating layer 3b) may be provided as the outermost surface layer of the layered photoreceptor 10. Alternatively, as shown in FIG. 7, the protective layer 5 may be provided as the outermost surface layer of the layered photoreceptor 10.

The charge generating layer 3a contains, for example, a charge generating agent and a base resin. The charge generating layer 3b may further contain an additive if necessary. The thickness of the charge generating layer 3 b is not particularly limited, but is preferably 0.01 μm or more and 5 μm or less, and more preferably 0.1 μm or more and 3 μm or less.

The charge transport layer 3b contains, for example, a hole transporting agent and a binder resin. The charge transport layer 3b may further contain an additive if necessary. The thickness of the charge transport layer 3c is not particularly limited, but is preferably 2 μm or more and 100 μm or less, and more preferably 5 μm or more and 50 μm or less. With reference to FIGS. 5 to 7, the layered photoreceptor 10 has been described. Hereinafter, the photoreceptor will be further described.

(Charge Generator)

The photosensitive layer (More specifically, the charge generating layer or the single-layer photosensitive layer) contains, for example, a charge generating agent. Examples of the charge generating agent include phthalocyanine pigment, perylene pigment, bisazo pigment, trisazo pigment, dithioketopyrrolopyrrole pigment, metal-free naphthalocyanine pigment, metal naphthalocyanine pigment, squalene pigment, indigo pigment, azulenium pigment, cyanine pigment, powder of inorganic photoconductive material (e.g., selenium, selenium-tellurium, selenium-arsenic, cadmium sulfide, or amorphous silicon), pyrylium pigment, ansanthrone pigment, triphenylmethane pigment, sulene pigment, toluidine pigment, pyrazoline pigment, and quinacridone pigment.

Examples of the phthalocyanine-based pigment include metal-free phthalocyanine and metal phthalocyanine. Examples of the metal phthalocyanine include titanyl phthalocyanine, hydroxygallium phthalocyanine, and chlorogallium phthalocyanine. The metal-free phthalocyanine is represented by chemical formula (CGM-1). The titanyl phthalocyanine is represented by chemical formula (CGM-2).

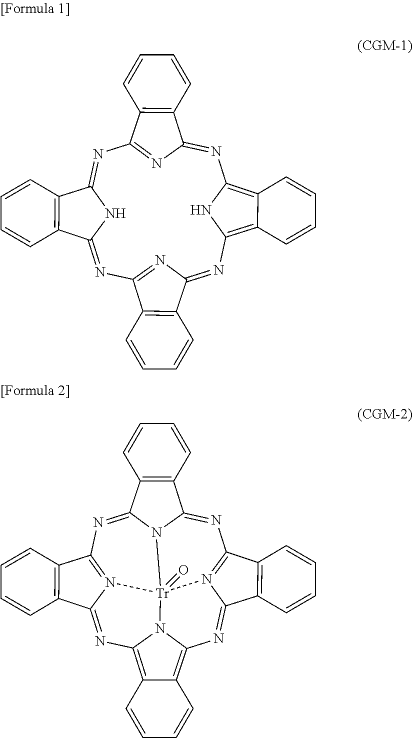

The phthalocyanine-based pigment may be a crystal or a non-crystal. Examples of the metal-free phthalocyanine crystal include an X-type crystal (hereinafter, it may be described as an X-type metal-free phthalocyanine) of the metal-free phthalocyanine. Examples of the crystal of titanyl phthalocyanine include α-form, β-form and Y-form crystals (hereinafter, each may be described as α-form, β-form, and Y-form titanyl phthalocyanines) of titanyl phthalocyanine.

For example, in a digital optical image forming apparatus (Laser beam printers or facsimiles using light sources such as, for example, semiconductor lasers), it is preferable to use a photoreceptor having sensitivity in a wavelength region of 700 nm or more. Since the charge generating agent has a high quantum yield in the wavelength region of 700 nm or more, a phthalocyanine-based pigment is preferable, a metal-free phthalocyanine or titanyl phthalocyanine is more preferable, an X-type metal-free phthalocyanine or a Y-type titanyl phthalocyanine is more preferable, and a Y-type titanyl phthalocyanine is particularly preferable.

The Y-type titanyl phthalocyanine has a main peak at, for example, Bragg angle (2θ±0.2°) of 27.2° in the CuKα characteristic X-ray diffraction spectrum. The main peak in the CuKα characteristic X-ray diffraction spectrum is a peak having the first or second largest intensity in the range of a Bragg angle (2θ±0.2°) of 3° to 40°. The Y-type titanyl phthalocyanine does not have a peak at 26.2° C. in the CuKα characteristic X-ray diffraction spectrum.

The CuKα characteristic X-ray diffraction spectrum is measured, for example, by the following method. First, a sample (titanyl phthalocyanine) is filled in a sample holder of an X-ray diffraction apparatus (For example, “RINT (registered trademark) 1100” manufactured by Rigaku Co., Ltd.), and the X-ray diffraction spectrum is measured under the conditions of an X-ray tube Cu, a tube voltage of 40 kV, a tube current of 30 mA, and a wavelength of CuKα characteristic X-ray of 1.542 Å. The measuring range (2θ) is, for example, 3° to 40° (Start angle 3°, Stop angle 40°), and the scanning speed is, for example, 10°/min. The main peak is determined from the obtained X-ray diffraction spectrum, and the Bragg angle of the main peak is read.

When the photoreceptor is a single-layer photoreceptor, the content of the charge generating agent is preferably 0.1 part by mass or more and 50 parts by mass or less with respect to parts 100 by mass of the binder resin, and more preferably 0.5 parts by mass or more and 5 parts by mass or less. When the photoreceptor is a layered photoreceptor, the content of the charge generating agent is preferably 10 parts by mass or more and 300 parts by mass or less, and more preferably 100 parts by mass or more and 200 parts by mass or less, with respect to 100 parts by mass of the base resin.

(Binder Resin)

The photosensitive layer (more specifically, a charge transport layer or a single-layer photosensitive layer) contains, for example, a binder resin. Examples of the binder resin include a thermoplastic resin, a thermosetting resin, and a photocurable resin. Examples of thermoplastic resins include polyarylate resins, polycarbonate resins, styrene-butadiene copolymers, styrene-acrylonitrile copolymers, styrene-maleic acid copolymers, acrylic acid polymers, styrene-acrylic acid copolymers, polyethylene resins, ethylene-vinyl acetate copolymers, chlorinated polyethylene resins, polyvinyl chloride resins, polypropylene resins, ionomer resins, vinyl chloride-vinyl acetate copolymers, alkyd resins, polyamide resins, urethane resins, polysulfone resins, diallyl phthalate resins, ketone resins, polyvinyl butyral resins, polyester resins, polyvinyl acetal resins, and polyether resins. Examples of the thermosetting resin include silicone resins, epoxy resins, phenol resins, urea resins, and melamine resins. Examples of the photo-curable resin include an acrylic acid adduct of an epoxy compound and an acrylic acid adduct of a urethane compound.

The viscosity average molecular weight of the binder resin is preferably 10,000 or more, more preferably 20,000 or more, still more preferably 30,000 or more, and particularly preferably 40,000 or more. When the viscosity average molecular weight of the binder resin is 10,000 or more, abrasion resistance of the binder resin is enhanced and abrasion of the photosensitive layer can be suppressed. On the other hand, the viscosity average molecular weight of the binder resin is preferably 80,000 or less, and more preferably 70,000 or less. When the viscosity average molecular weight of the binder resin is 80,000 or less, the binder resin is easily dissolved in the solvent for forming the photosensitive layer, and the formation of the photosensitive layer is facilitated.

The binder resin is preferably a polyarylate resin. The polyarylate resin is preferably a polyarylate resin containing at least 1 repeating unit represented by general formula (10) and at least 1 repeating unit represented by general formula (11). Hereinafter, a polyarylate resin containing at least 1 kind of repeating unit represented by general formula (10) and at least 1 kind of repeating unit represented by general formula (11) may be described as a polyarylate resin (PA). In addition, the repeating units represented by formulae (10) and (11) may be described as repeating units (10) and (11), respectively.

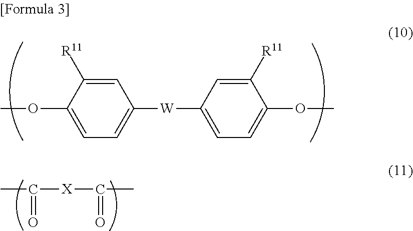

In formula (10), R¹¹ and R¹² each independently represent a hydrogen atom or a methyl group. In the general formula (10), W represents a divalent group represented by general formula (W1), general formula (W2), or chemical formula (W3).

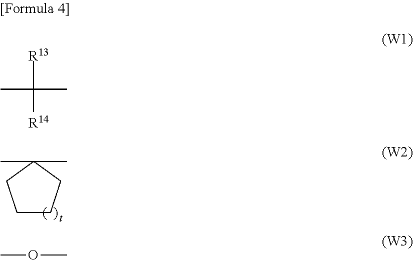

In the general formula (W1), R¹³ represents a hydrogen atom or an alkyl group having 1 to 4 carbon atoms, and R¹⁴ represents an alkyl group having 1 to 4 carbon atoms. In the general formula (W2), t represents an integer of 1 to 3, inclusive.

In the general formula (11), X represents a divalent group represented by chemical formula (X1), chemical formula (X2), or chemical formula (X3).

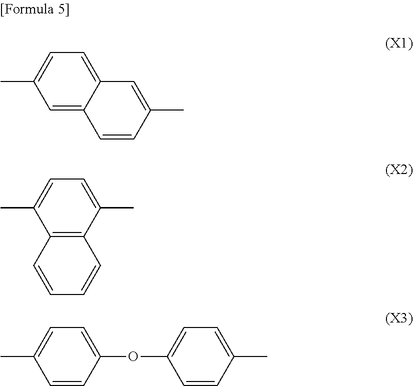

As the alkyl group represented by R¹³ in the general formula (W1) and having 1 to 4 carbon atoms, a methyl group is preferable. As the alkyl group represented by R¹⁴ in the general formula (W1) and having 1 to 4 carbon atoms, an alkyl group having 2 to 4 carbon atoms is preferable, and an ethyl group is more preferable. It is preferable that t in the general formula (W2) represents 2.

Preferred examples of the repeating unit (10) include repeating units represented by chemical formulas (10-1), (10-2), and (10-3) (hereinafter, each may be described as a repeating unit (10-1), (10-2), and (10-3)).

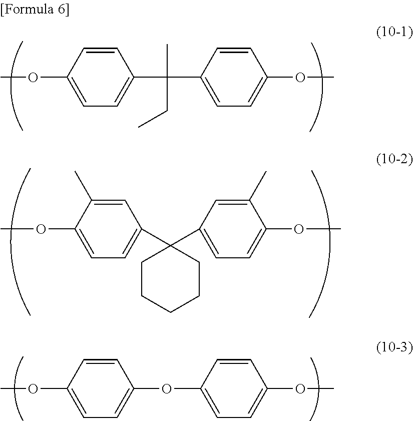

Preferred examples of the repeating unit (11) include repeating units represented by chemical formulas (11-X1), (11-X2), and (11-X3) (hereinafter, each may be described as a repeating unit (11-X1), (11-X2), and (11-X3)).

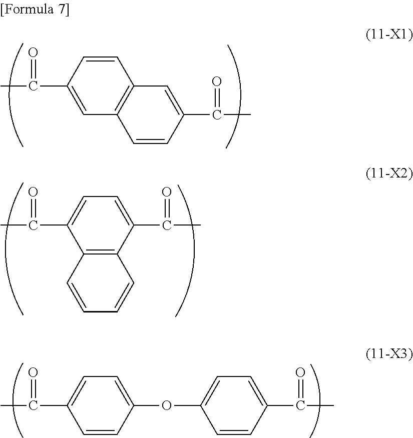

The polyarylate resin (PA) preferably contains repeating units (11-X1) and (11-X3). In this case, the ratio of the number of the repeating units (11-X1) to the total number of the repeating units (11-X1) and (11-X3) (hereinafter may be referred to as the ratio p) is preferably from 0.10 to 0.90, inclusive, more preferably from 0.20 to 0.80, inclusive, still more preferably from 0.30 to 0.70, inclusive, still more preferably from 0.40 to 0.60, inclusive, and particularly preferably 0.50. The ratio p is calculated, for example, by measuring the 1H-NMR spectrum of the polyarylate resin (PA) using a proton nuclear magnetic resonance spectrometer.

The polyarylate resin (PA) preferably contains at least 1 kind of repeating unit (10) and at least 2 kinds of repeating unit (11). The polyarylate resin (PA) preferably contains 1 kind of repeating unit (10) and 2 kinds of repeating unit (11). As shown in the following chemical formula, the polyarylate resin (PA) further preferably contains repeating units (10-2), (11-X1), and (11-X3). Hereinafter, a polyarylate resin containing repeating units (10-2), (11-X1), and (11-X3) may be referred to as a first polyarylate resin.

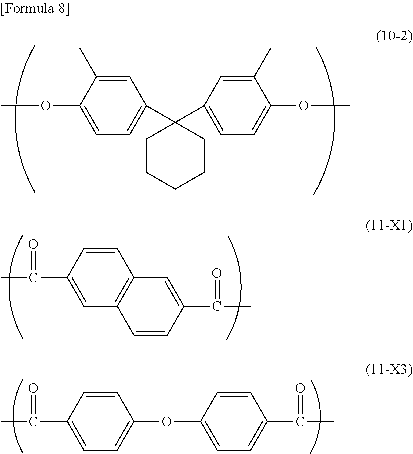

The polyarylate resin (PA) is particularly preferably a polyarylate resin represented by chemical formula (R-1) (hereinafter this may be referred to as polyarylate resin (R-1)). In the chemical formula (R-1), the numbers to the lower right of the repeating units indicate the percentage of the number of the corresponding repeating units to the total number of repeating units of the polyarylate resin (R-1) (unit: mol %).

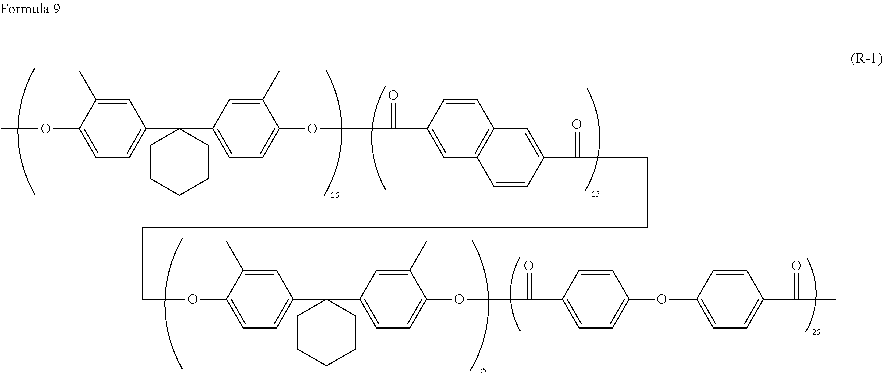

In the polyarylate resin (PA), a repeating unit (10) derived from an aromatic diol and a repeating unit (11) derived from an aromatic dicarboxylic acid are mutually bonded adjacently. When the polyarylate resin (PA) is a copolymer, the polyarylate resin (PA) may be any of a random copolymer, an alternating copolymer, a cyclic copolymer, and a block copolymer. The polyarylate resin (PA) may contain only repeating units (10) and (11) as repeating units. Alternatively, the polyarylate resin (PA) may further contain repeating units other than the repeating units (10) and (11) in addition to the repeating units (10) and (11). Further, the photosensitive layer may contain only a polyarylate resin (PA) as the binder resin, or may further contain a binder resin other than the polyarylate resin (PA) in addition to the polyarylate resin.

The method for manufacturing the polyarylate resin (PA) is not particularly limited. The method for manufacturing the polyarylate resin (PA) includes, for example, a method for polycondensing an aromatic diol for forming a repeating unit (10) and an aromatic dicarboxylic acid for forming the repeating unit (11). As the method of polycondensation, a known synthetic method (More specifically, solution polymerization, melt polymerization, interface polymerization, etc.) can be adopted.

The aromatic diol for forming the repeating unit (10) is a compound represented by general formula (BP-10) (hereinafter, it may be described as a compound (BP-10)). The aromatic dicarboxylic acid for forming the repeating unit (11) is a compound represented by general formula (DC-11) (hereinafter, it may be described as a compound (DC-11)). In formulae (BP-10) and (DC-11), R¹¹, R¹², W, and X are synonymous with R¹¹, R¹², W, and X in formulae (10) and (11), respectively.

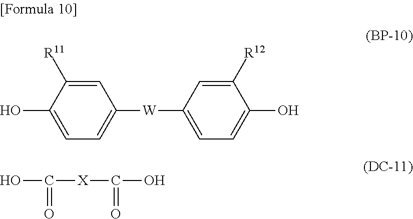

(Base Resin)

The photosensitive layer (More specifically, the charge generating layer) contains, for example, a base resin. Examples of the base resin are the same as those of the binder resin described above. In order to form the charge generating layer and the charge transport layer favorably, the base resin contained in the charge generating layer is preferably different from the binder resin contained in the charge transport layer.

(Electron Transporting Agent)

The photosensitive layer (More specifically, the single-layer photosensitive layer) contains, for example, an electron transporting agent. Examples of the electron transporting agent include a quinone compound, a diimide compound, a hydrazone compound, a malononitrile compound, a thiopyran compound, a trinitrothioxanthone compound, a 3,4,5,7-tetranitro-9 fluorenone compound, a dinitroanthracene compound, a dinitroacridine compound, a tetracyanoethylene, 2,4,8-trinitrothioxanthone, dinitrobenzene, dinitroacridine, succinic anhydride, maleic anhydride, and dibromomaleic anhydride. Examples of the quinone-based compound include a diphenoquinone-based compound, an azoquinone-based compound, an anthraquinone-based compound, a naphthoquinone-based compound, a nitroanthraquinone-based compound, and a dinitroanthraquinone-based compound.

Suitable examples of electron transporting agents include compounds of the general formulae (20), (21), (22), and (23) (hereinafter, each may be described as an electron transporting agent (20), (21), (22), and (23)).

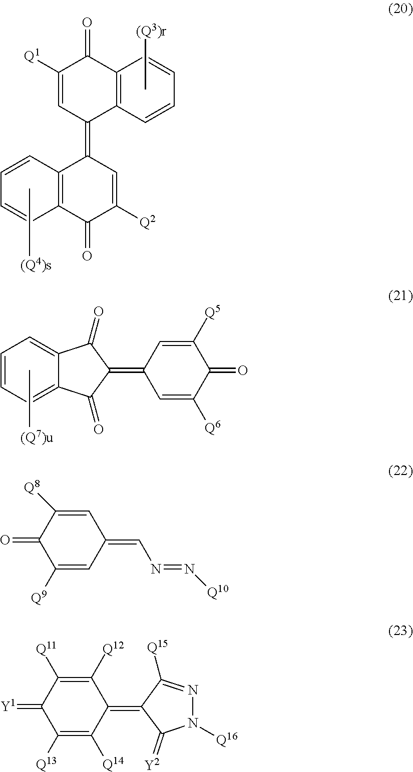

In formula (20), Q¹ and Q² each independently represent a hydrogen atom, an alkyl group having 1 to 8 carbon atoms, a phenyl group, or an alkoxy group having 1 to 8 carbon atoms. Q³ and Q⁴ independently represent an alkyl group having 1 to 8 carbon atoms, a phenyl group, or an alkoxy group having 1 to 8 carbon atoms. r and s each independently represent an integer of 0 to 4, inclusive.

In the general formula (20), when r represents an integer of 2 or more and 4 or less, a plurality of Q³ may each represent the same group, or may represent different groups. When s represents an integer of 2 to 4, inclusive, the plurality of Q⁴ may represent the same group or different groups.

In the general formula (20), Q¹ and Q² each independently represent an alkyl group having 1 to 8 carbon atoms, more preferably an alkyl group having 1 to 6 carbon atoms, still more preferably an alkyl group having 5 carbon atoms, and particularly preferably a 1,1-dimethylpropyl group. Preferably, r and s each represent 0.

In formula (21), Q⁵ and Q⁶ each independently represent a hydrogen atom, an alkyl group having 1 to 8 carbon atoms, a phenyl group, or an alkoxy group having 1 to 8 carbon atoms. Q⁷ represents:

an alkyl group having 1 to 8 carbon atoms, a phenyl group, or an alkoxy group having 1 to 8 carbon atoms. u represents an integer of 0 to 4, inclusive.

In the general formula (21), when u represents an integer of 2 to 4, inclusive, the plurality of Q⁷ may represent the same group or different groups.

In the general formula (21), Q⁵ and Q⁶ each preferably independently represent an alkyl group having 1 to 8 carbon atoms, more preferably an alkyl group having 1 to 6 carbon atoms, still more preferably an alkyl group having 4 carbon atoms, and particularly preferably a tert-butyl group. It is preferable that u represents 0.

In formula (22), Q⁸ and Q⁹ each independently represent a hydrogen atom or an alkyl group having 1 to 6 carbon atoms. Q¹⁰ represents an aryl group having 6 to 14 carbon atoms which may be substituted with a halogen atom.

In formula (22), Q⁸ and Q⁹ each preferably independently represent an alkyl group having 1 to 6 carbon atoms, more preferably an alkyl group having 4 carbon atoms, and particularly preferably a tert-butyl group. Q¹⁰ preferably represents an aryl group having 6 to 14 carbon atoms substituted with a halogen atom, more preferably represents a phenyl group substituted with a halogen atom, further preferably represents a chlorophenyl group, and particularly preferably represents a 4-chlorophenyl group.

In formula (23), Q¹¹, Q¹², Q¹³, Q¹⁴, Q¹⁵, and Q¹⁶ each independently represent a hydrogen atom, an alkyl group having 1 to 6 carbon atoms, or an aryl group having 6 to 14 carbon atoms. Y¹ represents an oxygen atom, a sulfur atom or ═C(CN)², and Y² represents an oxygen atom or a sulfur atom.

As the alkyl group represented by Q¹¹, Q¹², Q¹³, Q¹⁴, Q¹⁵, and Q¹⁶ and having 1 to 6 carbon atoms, an alkyl group having 1 to 4 carbon atoms is preferable, an alkyl group having 4 carbon atoms is more preferable, and a tert-butyl group is more preferable. As the aryl group represented by Q¹¹, Q¹², Q¹³, Q¹⁴, Q¹⁵, and Q¹⁶ and having 6 to 14 carbon atoms, an aryl group having 6 to 10 carbon atoms is preferable, and a phenyl group is more preferable. Y¹ preferably represents an oxygen atom, and Y² preferably represents an oxygen atom.

The electron transporting agent (20) is preferably a compound represented by chemical formula (E-1). The electron transporting agent (21) is preferably a compound represented by chemical formula (E-3). The electron transporting agent (22) is preferably a compound represented by chemical formula (E-2). The electron transporting agent (23) is preferably a compound represented by chemical formula (E-4). The compounds represented by chemical formulae (E-1) to (E-4) may be described as electron transporting agents (E-1) to (E-4), respectively.

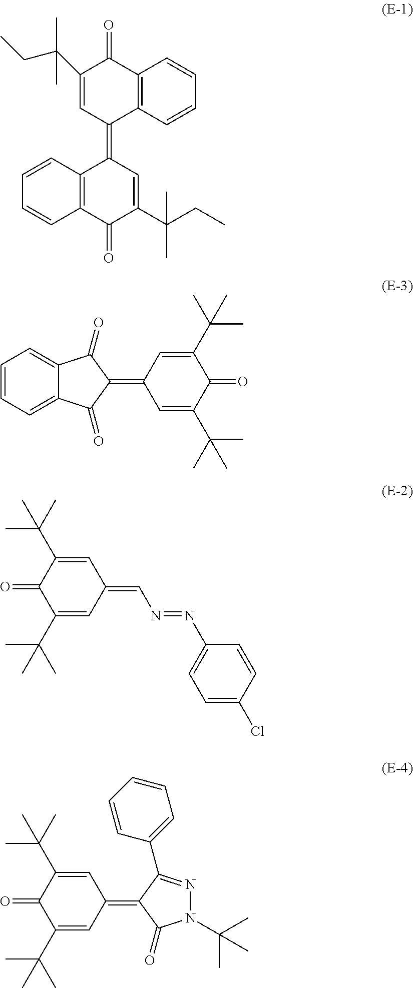

The content of the electron transporting agent per 100 parts by mass of the binder resin is preferably 5 to 150 parts by mass, preferably 10 to 100 parts by mass, and more preferably 40 to 60 parts by mass.

Hole Transporting Agent)

The photosensitive layer (more specifically, a charge transport layer or a single-layer photosensitive layer) contains, for example, a hole transporting agent. Examples of the hole transporting agent include a triphenylamine derivative, a diamine derivative (For example, N, N, N′, N′-tetraphenylbenzidine derivatives, N, N, N′, N′-tetraphenylphenylenediamine derivatives, N, N, N′, N′-tetraphenylnaphthylenediamine derivatives, N, N, N′, N′-tetraphenylphenanthrylenediamine derivatives, and di (aminophenylethenyl) benzene derivatives), an oxadiazole compound (e.g., 2,5-di (4-methylaminophenyl)-1, 3, 4-oxadiazole), a styryl compound (e.g., 9-(4-diethylaminostyryl) anthracene), a carbazole compound (e.g., polyvinyl carbazole), an organic polysilane compound, a pyrazoline compound (e.g., 1-phenyl-3-(p-dimethylaminophenyl) pyrazoline), a hydrazone compound, an indole compound, an oxazole compound, an isoxazole compound, a thiazole compound, a thiadiazole compound, an imidazole compound, a pyrazole compound, and a triazole compound.

Suitable examples of hole transporting agents include compounds of the general formulae (30), (31), and (32) (hereinafter, each may be described as a hole transporting agent (30), (31), and (32)).

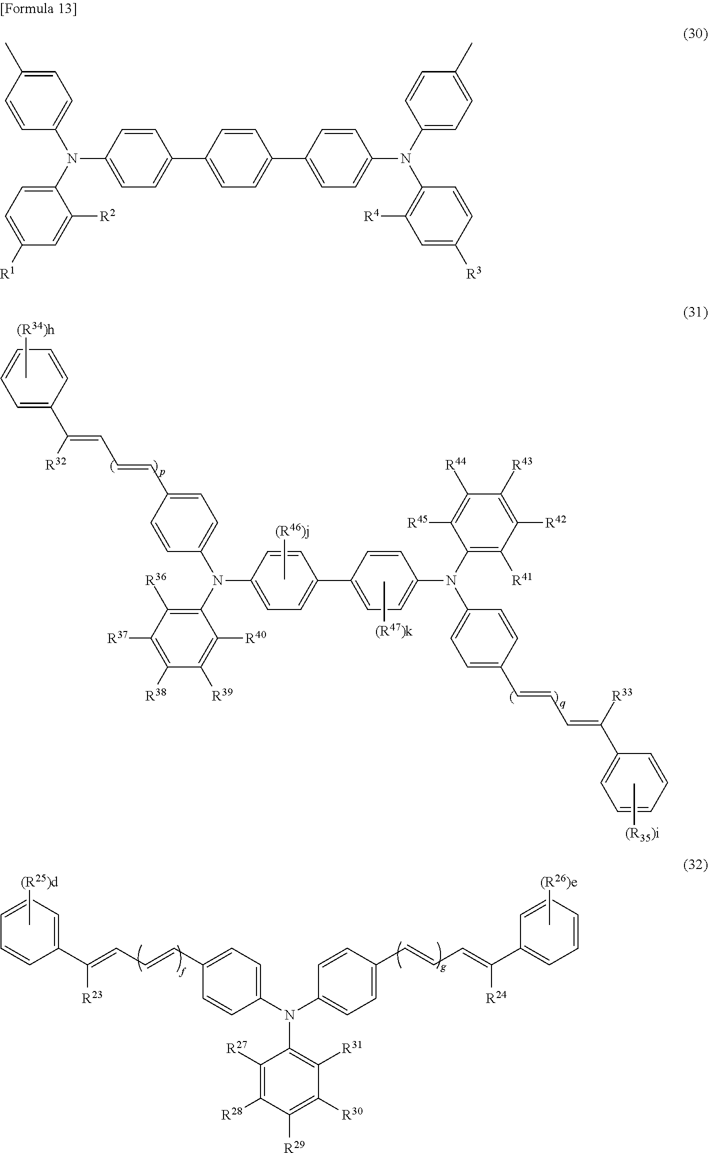

In formula (30), R¹ and R² each independently represent a hydrogen atom, a methyl group, or an ethyl group, and the sum of the number of carbon atoms of the group represented by R¹ and the number of carbon atoms of the group represented by R² is 2. R³ and R⁴ each independently represent a hydrogen atom, a methyl group, or an ethyl group, and, and the sum of the number of carbon atoms of the group represented by R³ and the number of carbon atoms of the group represented by R⁴ is 2.

In the general formula (31), R³² and R³³ each independently represents a hydrogen, atom, an alkyl group having 1 to 8 carbon atoms, or a phenyl group; R³⁴, R³⁵, R⁴⁶ and R⁴⁷ each independently represents an alkyl group or a phenyl group having 1 to 8 carbon atoms; R³⁶ to R⁴⁵ each independently represents a hydrogen atom, an alkyl group having 1 to 8 carbon atoms, or a phenyl group; p and q each independently represents 0 or 1; h and i independently represents an integer of 0 to 5, inclusive; and j and k independently represent an integer of 0 to 4, inclusive.

In the general formula (31), when h represents an integer of 2 to 5, inclusive, the plurality of R³⁴ may represent the same group or different groups. When i represents an integer of 2 to 5, inclusive, the plurality of R³⁵ may represent the same group or different groups. When j represents an integer of 2 to 4, inclusive, the plurality of R⁴⁶ may represent the same group or different groups. When k represents an integer of 2 to 4, inclusive, the plurality of R⁴⁷ may represent the same group or different groups.

In formula (31), R³² and R³³ each preferably represents a hydrogen atom. Preferably, R³⁶ to R⁴⁵ each independently represents a hydrogen atom or an alkyl group having 1 to 8 carbon atoms. As the alkyl group represented by R³⁶ to R⁴⁵ and having 1 to 8 carbon atoms, an alkyl group having 1 to 6 carbon atoms is preferable, an alkyl group having 1 to 3 carbon atoms is more preferable, and a methyl group or an ethyl group is more preferable. Preferably, h and i each represent 0. Preferably, j and k each represent 0.

In the general formula (32), R²³ and R²⁴ each independently represent a hydrogen atom, an alkyl group having 1 to 8 carbon atoms, an alkoxy group having 1 to 8 carbon atoms, or a phenyl group which may be substituted with an alkyl group having 1 to 8 carbon atoms. R²⁵ and R²⁶ each independently represent an alkyl group having 1 to 8 carbon atoms, an alkoxy group having 1 to 8 carbon atoms, or a phenyl group. R²⁷, R²⁸, R²⁹, R³⁹ and R³¹ each independently represent a hydrogen atom, an alkyl group having 1 to 8 carbon atoms, an alkoxy group having 1 to 8 carbon atoms, or a phenyl group. Of R²⁷, R²⁸, R²⁹, R³⁹ and R³¹, 2 adjacent ones may bond to each other to represent a ring. d and e each independently represent an integer of 0 to 5, inclusive. f and g each independently represent 1 or 2.

In the general formula (32), when d represents an integer of 2 to 5, inclusive, the plurality of R²⁵ may represent the same group or different groups. When e represents an integer of 2 to 5, inclusive, the plurality of R²⁶ may represent the same group or different groups. When two adjacent ones of R²⁷, R²⁸, R²⁹, R³⁰ and R³¹ are bonded to each other to form a ring, the ring and a phenyl group to which R²⁷, R²⁸, R²⁹, R³⁰ and R³¹ are bonded are condensed to form a bicyclic condensed ring group. In this case, the condensation site between the ring and the phenyl group may include a double bond.

In formula (32), R²³ and R²⁴ each preferably represent a hydrogen atom. Preferably, R²⁷, R²⁸, R²⁹, R³⁰ and R³¹ each independently represent a hydrogen atom or an alkoxy group having 1 to 8 carbon atoms. As the alkoxy group represented by R²⁷, R²⁸, R²⁹, R³⁰ and R³¹ and having 1 to 8 carbon atoms, an alkoxy group having 1 to 6 carbon atoms is preferable, an alkoxy group having 1 to 3 carbon atoms is more preferable, and an ethoxy group is more preferable. Preferably, d and e each represent 0.

The hole transporting agent (30) is preferably a compound represented by chemical formula (H-1). The hole transporting agent (31) is preferably a compound represented by chemical formulas (H2) and (H-3). The hole transporting agent (32) is preferably a compound represented by chemical formula (H-4). Hereinafter, compounds represented by chemical formulae (H-1) to (H-4) may be described as hole transporting agents (H-1) to (30), respectively.

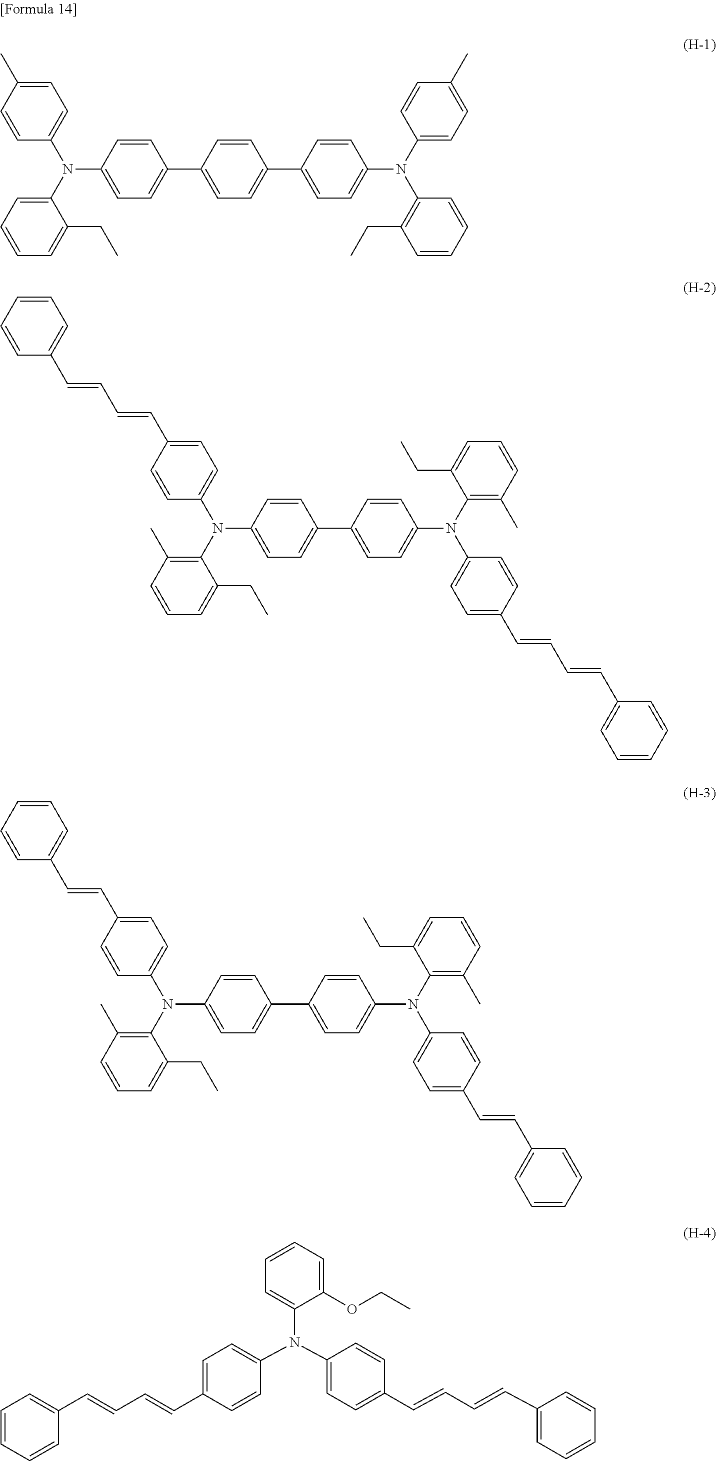

In the case where the photoreceptor is a single-layer photoreceptor or the photoreceptor is a layered photoreceptor, the content of the hole transporting agent is preferably 10 parts by mass or more and 200 parts by mass or less, more preferably 50 pts.mass or more and 150 parts by mass or less, with respect to 100 parts by mass of the binder resin.

(Additive)

The photosensitive layer (more specifically, a charge generating layer, a charge transport layer, or a single-layer photosensitive) may optionally contain an additive. Additives include, for example, antioxidants, radical scavengers, singlet quenchers, ultraviolet absorbers, softeners, surface modifiers, extenders, thickeners, dispersion stabilizers, waxes, donors, surfactants, plasticizers, sensitizers, electron acceptor compounds, and leveling agents.

(Material Combination)

When the photoreceptor is a single-layer photosensitive layer, in order to improve the pressure resistance of the photoreceptor and suppress the fluctuation of the sensitivity characteristics of the photoreceptor due to humidity, it is preferable that the polyamide resin and metal particles contained in the undercoat layer and the hole transporting agent, electron transporting agent and polyarylate resin contained in the single-layer photosensitive layer are each combination No. S1 to S16 shown in Table 1. For the same reason, it is preferable that the polyamide resin and the metal particles contained in the undercoat layer and the hole transporting agent, the electron transporting agent, and the polyarylate resin contained in the single-layered photosensitive layer are each of the combinations No. S1 to S16 shown in Table 1, and the coat layer of the metal particles contained in the undercoat layer further contains silica. For the same reason, it is preferable that the polyamide resin and the metal particles contained in the undercoat layer and the hole transporting agent, the electron transporting agent, and the polyarylate resin contained in the single-layer photosensitive layer are each of the combination Nos. S1 to S16 shown in Table 1, and the charge generating agent is Y-type titanyl phthalocyanine.

TABLE 1

| | Undercoat layer | | | | | |
|---|---|---|---|---|---|---|
| | Polyamide | | | Single-layer | | |
| | resin | Metal particles | | photosensitive layer | | |
| | Absorption | Core | Coat | | | Polyarylate |
| No. | rate | particles | layer | HTM | ETM | resin |
| S1 | 0.70-1.00 | TiO₂ | Alumina | H-1 | E-1 | First |
| S2 | 0.70-1.00 | TiO₂ | Alumina | H-1 | E-2 | First |
| S3 | 0.70-1.00 | TiO₂ | Alumina | H-1 | E-3 | First |
| S4 | 0.70-1.00 | TiO₂ | Alumina | H-1 | E-4 | First |
| S5 | 1.00-2.00 | TiO₂ | Alumina | H-1 | E-1 | First |
| S6 | 1.00-2.00 | TiO₂ | Alumina | H-1 | E-2 | First |
| S7 | 1.00-2.00 | TiO₂ | Alumina | H-1 | E-3 | First |
| S8 | 1.00-2.00 | TiO₂ | Alumina | H-1 | E-4 | First |
| S9 | 0.70-1.00 | TiO₂ | Alumina | H-1 | E-1 | R-1 |
| S10 | 0.70-1.00 | TiO₂ | Alumina | H-1 | E-2 | R-1 |
| S11 | 0.70-1.00 | TiO₂ | Alumina | H-1 | E-3 | R-1 |
| S12 | 0.70-1.00 | TiO₂ | Alumina | H-1 | E-4 | R-1 |
| S13 | 1.00-2.00 | TiO₂ | Alumina | H-1 | E-1 | R-1 |
| S14 | 1.00-2.00 | TiO₂ | Alumina | H-1 | E-2 | R-1 |
| S15 | 1.00-2.00 | TiO₂ | Alumina | H-1 | E-3 | R-1 |
| S16 | 1.00-2.00 | TiO₂ | Alumina | H-1 | E-4 | R-1 |

When the photoreceptor is a layered photosensitive layer, it is preferable that the polyamide resin and metal particles contained in the undercoat layer and the hole transporting agent and polyarylate resin contained in the charge transporting layer are each of the combination Nos. M1 to M16 shown in Table 2 in order to improve the pressure resistance of the photoreceptor and suppress the fluctuation of the sensitivity characteristics of the photoreceptor due to humidity. For the same reason, it is preferable that the polyamide resin and the metal particles contained in the undercoat layer and the hole transporting agent and the polyarylate resin contained in the charge transport layer are each of the combination Nos. M1 to M 16 shown in Table 2, and the coat layer of the metal particles contained in the undercoat layer further contains silica. For the same reason, it is preferable that the polyamide resin and metal particles contained in the undercoat layer and the hole transporting agent and polyarylate resin contained in the charge transporting layer are each of the combinations No. M1 to M16 shown in Table 2, and the charge transporting layer further contains a hindered phenol antioxidant. For the same reason, it is preferable that the polyamide resin and the metal particles contained in the undercoat layer and the hole transporting agent and the polyarylate resin contained in the charge transporting layer are each of the combination Nos. M1 to M16 shown in Table 2, and the charge generating agent contained in the charge generating layer is Y-type titanyl phthalocyanine.

TABLE 2

| | Undercoat layer | | | | |
|---|---|---|---|---|---|
| | Polyamide | | | Single-layer | |
| | resin | Metal particles | | photosensitive layer | |
| | Absorption | Core | Coat | | Polyarylate |
| No. | rate | particles | layer | HTM | resin |
| M1 | 0.70-1.00 | TiO₂ | Alumina | H-1 | First |
| M2 | 0.70-1.00 | TiO₂ | Alumina | H-2 | First |
| M3 | 0.70-1.00 | TiO₂ | Alumina | H-3 | First |
| M4 | 0.70-1.00 | TiO₂ | Alumina | H-4 | First |
| M5 | 1.00-2.00 | TiO₂ | Alumina | H-1 | First |
| M6 | 1.00-2.00 | TiO₂ | Alumina | H-2 | First |
| M7 | 1.00-2.00 | TiO₂ | Alumina | H-3 | First |
| M8 | 1.00-2.00 | TiO₂ | Alumina | H-4 | First |
| M9 | 0.70-1.00 | TiO₂ | Alumina | H-1 | R-1 |
| M10 | 0.70-1.00 | TiO₂ | Alumina | H-2 | R-1 |
| M11 | 0.70-1.00 | TiO₂ | Alumina | H-3 | R-1 |
| M12 | 0.70-1.00 | TiO₂ | Alumina | H-4 | R-1 |
| M13 | 1.00-2.00 | TiO₂ | Alumina | H-1 | R-1 |
| M14 | 1.00-2.00 | TiO₂ | Alumina | H-2 | R-1 |
| M15 | 1.00-2.00 | TiO₂ | Alumina | H-3 | R-1 |
| M16 | 1.00-2.00 | TiO₂ | Alumina | H-4 | R-1 |

The meanings of the terms in Tables 1 and 2 above are as follows. “No.” indicates the combination No. “HTM” indicates a hole transporting agent. “ETM” indicates an electron transporting agent. “0.70-1.00” indicates 0.70 or more and less than 1.00. “1.00-2.00” is 1.00 or more and 2.00 or less. “TiO₂” indicates titanium oxide.

(Conductive Substrate)

The conductive substrate is not particularly limited as long as it can be used as the conductive substrate of the photoreceptor. The conductive substrate may have at least a surface portion made of a material having conductivity. An example of the conductive substrate is a conductive substrate made of a conductive material. Another example of a conductive substrate is a conductive substrate coated with a conductive material. Examples of materials having conductivity include aluminum, iron, copper, tin, platinum, silver, vanadium, molybdenum, chromium, cadmium, titanium, nickel, palladium, indium, stainless steel, and brass. These materials having conductivity may be used alone, or 2 or more materials may be used in combination (for example, as an alloy). Among these materials having conductivity, aluminum and an aluminum alloy are preferable because charge transfer from the photosensitive layer to the conductive substrate is favorable therein.

The shape of the conductive substrate is appropriately selected in accordance with the structure of the image forming apparatus. Examples of the shape of the conductive substrate include a sheet shape and a drum shape. The thickness of the conductive substrate is appropriately selected according to the shape of the conductive substrate.

(Manufacturing Method of Photoreceptor)

A method of manufacturing a photoreceptor includes a step of forming a undercoat layer on a conductive substrate, and a step of forming a photosensitive layer on the undercoat layer.

The step of forming the undercoat layer is as described in the second embodiment. The object to be coated described in the second embodiment corresponds to a conductive substrate in the third embodiment.

Next, the photosensitive layer forming step will be described. When the photoreceptor is a single-layer photoreceptor, the photosensitive layer forming step is a single-layer photosensitive layer forming step. In the single-layer photosensitive layer forming step, a coating liquid (hereinafter, it may be referred to as a coating liquid for a single-layer photosensitive layer) for forming the single-layer photosensitive layer is prepared. A coating liquid for a single-layer photosensitive layer is coated on the undercoat layer. Then, the solvent contained in the applied coating liquid for the single-layer photosensitive layer is dried to form the single-layer photosensitive layer. The coating liquid for the single-layer photosensitive layer contains, for example, a charge generating agent, a hole transporting agent, an electron transporting agent, a binder resin, and a solvent. The coating liquid for the single-layer photosensitive layer may further contain an additive, if necessary.

When the photoreceptor is a layered photoreceptor, the photosensitive layer forming step includes a charge generating layer forming step and a charge transport layer forming step. In the charge generating layer forming step, a coating liquid (hereinafter, it may be referred to as a charge generating layer coating liquid) for forming the charge generating layer is prepared. A coating liquid for a charge generating layer is coated on the undercoat layer. Next, the solvent contained in the applied charge generating layer coating liquid is dried to form the charge generating layer. The charge generating layer coating liquid coating liquid contains, for example, a charge generating agent, a base resin and a solvent. The charge generating layer coating liquid may further contain an additive as necessary.

In a charge transport layer forming step, a coating liquid (hereinafter, it may be referred to as a charge transport layer coating liquid) for forming a charge transport layer is prepared. A charge transport layer coating liquid is coated on the charge generating layer. Next, the solvent contained in the applied charge transport layer coating liquid is dried to form the charge transport layer. The charge transport layer coating liquid contains a hole transporting agent, a binder resin and a solvent. The charge transport layer coating liquid may further contain an additive as necessary.

Examples of the solvent contained in the coating liquid for the single-layer photosensitive layer, the charge generating layer coating liquid, and the charge transport layer coating liquid (hereinafter, these are collectively referred to as the photosensitive layer coating liquid) include alcohols (more specifically, methanol, ethanol, isopropanol, butanol, and the like), aliphatic hydrocarbons (more specifically, n-hexane, octane, cyclohexane, etc.), aromatic hydrocarbons (more specifically, benzene, toluene, xylene, etc.), halogenated hydrocarbons (more specifically, dichloromethane, dichloroethane, carbon tetrachloride, chlorobenzene, etc.), ethers (More specifically, dimethyl ether, diethyl ether, tetrahydrofuran, ethylene glycol dimethyl ether, diethylene glycol dimethyl ether, and the like are provided), ketones (more specifically, acetone, methyl ethyl ketone, cyclohexanone, etc.), esters (more specifically, ethyl acetate, methyl acetate, etc.), dimethyl formaldehyde, dimethyl formamide, and dimethyl sulfoxide.

Preferred examples of the methods for dispersing and applying the photosensitive layer coating liquid the method for applying the coating liquid, and the method for drying the coating liquid are the same as those of the method for dispersing the coating liquid for the undercoat layer, the method for applying the coating liquid, and the method for drying the coating liquid described in the second embodiment.

### Fourth Embodiment: Image Forming Apparatus

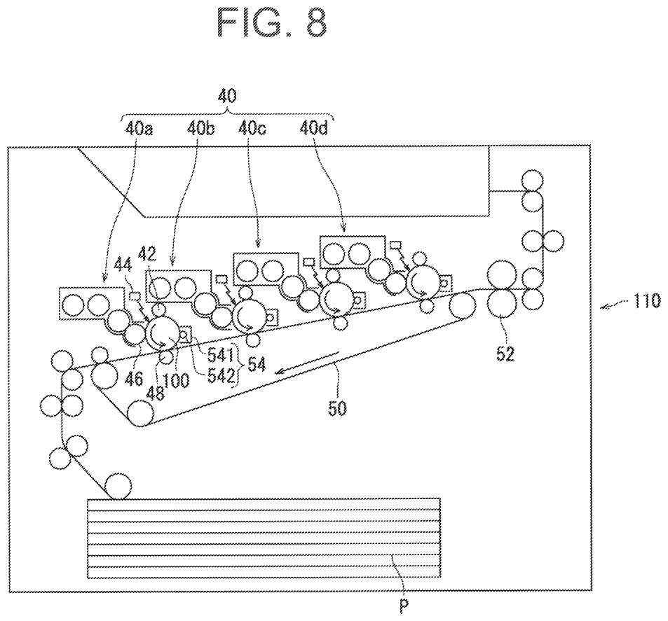

A fourth embodiment of the present disclosure relates to an image forming apparatus. An example of the image forming apparatus according to the fourth embodiment will be described below with reference to FIG. 8.

The image forming apparatus 110 shown in FIG. 8 includes image forming units 40a, 40b, 40c, and 40d, a transfer belt 50, and a fixing device 52. Hereinafter, each of the image forming units 40a, 40b, 40c, and 40d will be referred to as an image forming unit 40 when there is no need to make a distinction.

The image forming unit 40 includes an image carrier 100 corresponding to a photoreceptor, a charging device 42, an exposure device 44, a developing device 46, a transfer device 48, and a cleaning device 54. At the center of the image forming unit 40, an image carrier 100 is provided. The image carrier 100 is rotatably provided in the direction indicated by the arrow in FIG. 8 (counterclockwise direction). Around the image carrier 100, a charging device 42, an exposure device 44, a developing device 46, a transfer device 48, and a cleaning device 54 are provided in the order described from the upstream side in the rotational direction of the image carrier 100. Each of the image forming units 40a to 40d sequentially overlaps toner images of a plurality of color (for example, four colors: black, cyan, magenta, and yellow) on the recording medium P on the transfer belt 50.

The image carrier 100 corresponds to the photoreceptor (More specifically, the single-layer photoreceptor 1 or the layered type photoreceptor 10) described in the third embodiment. As described in the third embodiment, the photoreceptor includes a conductive substrate 2, a photosensitive layer 3 containing a charge generating agent, and an undercoat layer 4 according to the first embodiment. The undercoat layer 4 is provided between the conductive substrate 2 and the photosensitive layer 3. Since the image forming apparatus 110 according to the fourth embodiment includes the photoreceptor having the undercoat layer 4 according to the first embodiment, the image forming apparatus 110 according to the fourth embodiment is excellent in pressure resistance and can suppress the fluctuation of sensitivity characteristics due to humidity for the same reason as that described in the first embodiment.

The charging device 42 charges the surface of the image carrier 100 (for example, a circumferential surface). The charging device 42 is, for example, a charging roller. When the image carrier 100 is the single-layer photoreceptor 1, the charging device 42 charges the surface of the image carrier 100 positively. When the image carrier 100 is the layered photoreceptor 10, the charging device 42 charges the surface of the image carrier 100 negatively.

The exposure apparatus 44 exposes the surface of the charged image carrier 100. Thus, an electrostatic latent image is formed on the surface of the image carrier 100. The electrostatic latent image is formed based on image data input to the image forming apparatus 110.

The developing device 46 supplies toner to the surface of the image carrier 100 and develops the electrostatic latent image as a toner image. The developing device 46 develops the electrostatic latent image as a toner image in contact with the surface of the image carrier 100. That is, the developing device 46 is in contact with the surface of the image carrier 100. The image forming apparatus 110 employs a contact developing system. The developing device 46 is, for example, a developing roller. When the developer is a one-component developer, the developing device 46 supplies toner as the one-component developer to the electrostatic latent image formed on the image carrier 100. When the developer is a two-component developer, the developing device 46 supplies toner out of toner and carrier contained in the two-component developer to the electrostatic latent image formed on the image carrier 100. The image carrier 100 carries a toner image composed of the supplied toner.

The transfer belt 50 conveys the recording medium P between the image carrier 100 and the transfer device 48. The transfer belt 50 is an endless belt. The transfer belt 50 is rotatably provided in the direction indicated by the arrow in FIG. 8 (clockwise direction).

The transfer device 48 transfers the toner image developed by the developing device 46 from the image carrier 100 to the recording medium P to be transferred. Specifically, in a state where the surface of the image carrier 100 is in contact with the recording medium P, the transfer device 48 transfers the toner image from the surface of the image carrier 100 to the recording medium P. That is, the image forming apparatus 110 adopts a direct transfer system. The transfer device 48 is, for example, a transfer roller.

The cleaning device 54 recovers the toner adhering to the surface of the image carrier 100. The cleaning device 54 includes a housing 541 and a cleaning roller 542. The cleaning device 54 is not provided with a cleaning blade. The cleaning roller 542 is arranged in the housing 541. The cleaning roller 542 is arranged so as to abut on the surface of the image carrier 100. The cleaning roller 542 polishes the surface of the image carrier 100 and recovers the toner adhering to the surface of the image carrier 100 into the housing 541.

The recording medium P to which the toner image is transferred by the transfer device 48 is conveyed by the transfer belt 50 to the fixing device 52. The fixing device 52 is, for example, a heating roller and/or a pressure roller. The unfixed toner image transferred by the transfer device 48 is heated and/or pressurized by the fixing device 52. By heating and/or pressurizing the toner image, the toner image is fixed on the recording medium P. As a result, an image is formed on the recording medium P.

Although an example of the image forming apparatus has been described above, the image forming apparatus is not limited to the image forming apparatus 110, and the following points can be changed, for example. The image forming apparatus 110 is a color image forming apparatus, but the image forming apparatus may be a monochrome image forming apparatus. In this case, the image forming apparatus may include only one image forming unit. Although the image forming apparatus 110 employs a tandem system, the image forming apparatus may employ a rotary system. Although the charging roller has been described as an example of the charging device 42, a charging device (For example, a charging brush, a scorotron charger, or a corotron charger) other than the charging roller may be used. Although the image forming apparatus 110 employs a contact developing method, the image forming apparatus may employ a non-contact developing method. Although the image forming apparatus 110 employs a direct transfer system, the image forming apparatus may employ an intermediate transfer system. When the image forming apparatus employs an intermediate transfer system, the object to be transferred corresponds to an intermediate transfer belt. The cleaning device 54 has a cleaning roller 542 and does not have a cleaning blade, but may be a cleaning device having a cleaning blade or a cleaning device having a cleaning roller 542 and a cleaning blade. The image forming unit 40 is not provided with a static eliminator, but the image forming unit may further include a static eliminator.

### Example

Hereinafter, the present disclosure will be described more specifically with reference to the examples, but the present disclosure is not limited to the scope of the examples.

[Manufacture of the Undercoat Layer]

The undercoat layers (UCL-1) to (UCL-6) according to Examples and Comparative Examples were prepared. The configurations of the undercoat layers (UCL-1) to (UCL-6) are shown in Table 3.

TABLE 3
Undercoat layer

| | | | | | | | | | | Charging |
|---|---|---|---|---|---|---|---|---|---|---|
| | | Polyamide resin | | | | Absorption | | | Volume | potential |
| | | | Absorbance | | | rate | Metal particles | | resistivity | difference |
| | No. | Type | Second | First | Second/first | [wt %] | Type | Configuration | [Ω · cm] | [V] |
| Example 1 | UCL-1 | PA201 | 4.9 | 6.2 | 0.79 | 1.4 | MT-05 | Titanium oxide | 1.0.E+10 | 4 |
| | | | | | | | | (Alumina, silica) | | |
| Example 2 | UCL-2 | PA100 | 6.3 | 4.3 | 1.47 | 0.2 | MT-05 | Titanium oxide | 3.3.E+10 | 7 |
| | | | | | | | | (Alumina, silica) | | |
| Comparative | UCL-3 | CM4000 | 0.9 | 1.8 | 0.50 | 7.2 | MT-05 | Titanium oxide | 1.3.E+10 | 26 |
| example 1 | | | | | | | | (Alumina, silica) | | |
| Comparative | UCL-4 | CM8000 | 2.8 | 8.7 | 0.32 | 10.4 | MT-05 | Titanium oxide | 3.5.E+10 | 30 |
| example 2 | | | | | | | | (Alumina, silica) | | |
| Comparative | UCL-5 | PA201 | 4.9 | 6.2 | 0.79 | 1.4 | S-1 | Tin oxide | 7.2.E+08 | 3 |
| example 3 | | | | | | | | (no surface treatment) | | |
| Comparative | UCL-6 | PA201 | 4.9 | 6.2 | 0.79 | 1.4 | SMT-A | Tin oxide | 2.6.E+11 | 13 |
| example 4 | | | | | | | | (methyl hydrogen | | |
| | | | | | | | | polysiloxane) | | |

The meanings of the terms in Table 3 are as follows. In the column “absorbance”, “first”, “second”, and “second/first” indicate the first absorbance, the second absorbance, and the absorption rate of the second absorbance to the first absorbance, respectively. The “water absorption rate” indicates the water absorption rate of the polyamide resin. “wt %” indicates % by mass. The “volume resistivity” indicates the volume resistivity of the undercoat layer. “. E+08” denotes ×10⁸, and “. E+10” denotes ×10¹⁰, and “. E+11” denotes ×10¹¹. The “charging potential difference” indicates a value calculated from expression (1) described in the first embodiment, that is, expression “|C_{HH}−C_{LL}|”.

The following metal particles and polyamide resin were used as the metal particles and polyamide resin described in Table 3. In Table 3, the “Configuration” column of “metal particle” shows the materials present on the outermost surface of the metal particles in parentheses.

<Metal Particle>

Metal Particles (MT-05): “MT-05” (the particle has a titanium oxide core and a coat layer (layer composed of alumina and silica) covering the titanium oxide core. Materials present on the outermost surface of the metal particles: alumina and silica. Number average primary particle size: 10 nm) manufactured by Teika Limited

Metal particles (S-1): “S-1” (configuration: tin oxide particles without surface treatment) manufactured by Mitsubishi Materials Electronics Kasei Corporation

Metal Particles (SMT-A): “SMT-A” (the particle has a titanium oxide core, a first coat layer (layer composed of alumina and silica) covering the titanium oxide core, and a second coat layer (layer composed of methyl hydrogen polysiloxane) covering the first coat layer; a material present on the outermost surface of metal particles: methyl hydrogen polysiloxane. Number average primary particle size: 10 nm) manufactured by Teika Limited

<Polyamide Resin>

Polyamide resin (PA 201): Made by T & K TOKA Co., Ltd. “PA 201”

Polyamide resin (PA 100): Made by T & K TOKA Co., Ltd. “PA 100”

Polyamide resin (CM 4000): “Amiran (registered trademark) CM 4000” manufactured by Toray Industries, Inc.

Polyamide resin (CM 8000): “Amiran (registered trademark) CM 8000” manufactured by Toray Industries, Inc.

<Manufacture of the Undercoat Layer (UCL-1)>

2.5 parts by mass of metal particles (MT-05), 1.0 part by mass of polyamide resin (PA 201), and 10.0 parts by mass of solvent were mixed using a bead mill for 24 hours to obtain a coating liquid for undercoat layer. The solvent was a mixed solvent in which 8.0 parts by mass of methanol, 1.0 parts by mass of butanol, and 1.0 parts by mass of toluene were mixed. The obtained coating liquid for the undercoat layer was filtered using a filter having a mesh size of 5 μm. The coating liquid for the undercoat layer was applied to the surface of the conductive substrate (drum-Like support made of aluminum) by a dip coating method, and dried at 120° C. for 30 minutes. In this manner, an undercoat layer (UCL-1) was formed on the conductive substrate. The thickness of the undercoat layer (UCL-1) was 2 μm.

<Manufacture of Undercoat Layers (UCL-2) to (UCL-4)>

Each of the undercoat layers (UCL-2) to (UCL-4) was prepared by the same method as the undercoat layer (UCL-1), except that the polyamide resin (PA201) was changed to a polyamide resin of the type shown in Table 3. The amount of the polyamide resin added in the manufacture of the undercoat layer was the same as that of the undercoat layer (UCL-1) which is 1.0 part by mass.

<Manufacture of Undercoat Layers (UCL-5) to (UCL-6)>

Each of the undercoat layers (UCL-5) to (UCL-6) was prepared by the same method as the undercoat layer (UCL-1), except that the metal particles (MT-05) were changed to the metal particles of the type shown in Table 3. The addition amount of the metal particles in the manufacture of the undercoat layer was the same as that of the undercoat layer (UCL-1) which is 2.5 parts by mass.

[Measuring Method]

<Measurement of Absorbance of Polyamide Resin>

The absorbance of the polyamide resin was measured using a Fourier Transform Infrared Spectrophotometer (PerkinElmer “SPECTRUMONE”) in an ATR measurement mode at a temperature of 23° C. and a relative humidity of 50%. The measurement conditions were as follows.

(Measurement Condition)

Attachment: ATR Accessory (made by Pike Technology “MIRacle (registered trademark)”)

Optical crystal: Ge

Resolution: 4 cm⁻¹

Accumulated flow: 16 times

From the obtained infrared absorption spectrum, the first absorbance (A₁) of the first peak derived from the amide group and the second absorbance (A₂) of the second peak derived from the alkylene group were read. The absorption rate was calculated from the expression “absorption rate=A₂/A₁”. The first absorbance (A₁), the second absorbance (A₂), and the absorption rate (A₂/A₁) of each polyamide resin are shown in Table 3 above. In the infrared absorption spectra of the polyamide resins (PA201), (PA100), (CM4000), and (CM8000), the first peak was identified at 1640 cm⁻¹ and the second peak at 2920 cm⁻¹.

<Measurement of Water Absorption Rate of Polyamide Resin>

The water absorption rate of the polyamide resin was measured under an environment of a temperature of 23° C. and a relative humidity of 50%. In a container containing 30 g of ion-exchanged water and having a capacity of 70 mL, 0.5 g of polyamide resin was added and immersed in ion-exchanged water for 96 hours. The ion-exchanged water was not stirred during immersion. After immersion for 96 hours, the polyamide resin was removed from the ion-exchanged water. A first nonwoven fabric and a second nonwoven fabric (All of them are made by Kuraray Kuraflex Co., Ltd. “Product Name: Claclean (registered trademark) Wiper SF-20 C”, size: 200 mm×250 mm, material: rayon polyester) were prepared. A first nonwoven fabric was placed on a horizontal stand, a polyamide resin immediately after taken out from ion-exchanged water was placed on the first nonwoven fabric, a second nonwoven fabric was placed on the polyamide resin, a weight (Weight: 500 g, Size of the contact surface with the second nonwoven fabric: 100 mm×140 mm) was placed on the second nonwoven fabric, and the second nonwoven fabric was left for 1 minute. Next, the mass of the polyamide resin after standing for 1 minute was measured to be the mass of the polyamide resin after immersion in water (unit: g). From the mass 0.5 g of the polyamide resin before immersion in water and the mass of the polyamide resin after immersion in water, the water absorption rate was calculated from the formula “Water Absorption Rate=100×(Mass of polyamide resin after immersion in water−Mass of polyamide before immersion in water)/Mass of Polyamide Resin after Immersion in Water=100×(Mass of the polyamide resin after immersion in water−0.5)/Mass of Polyamide Resin after Immersion in Water” of the polyamide resin is calculated (unit:% mass). The water absorption rate of each polyamide resin is shown in Table 3.

<Measurement of the Volume Resistivity of the Undercoat Layer>

The volume resistivity of the undercoat layer was measured in an environment having a temperature of 23° C. and a relative humidity of 50%. As a measurement sample, the conductive substrate having the undercoat layer manufactured in the above [manufacture of the undercoat layer] was used. Note that this measurement sample did not have a photosensitive layer. A first electrode (Circular silver electrode with a radius of 5.5 mm, manufactured by Kaken Tech Co., Ltd. “TK PASTE (registered trademark) CN-7120”) was attached to the outer peripheral surface of the undercoat layer. A second electrode (circular silver electrode with a radius of 5.5 mm, manufactured by Kaken Tech Co., Ltd. “TK PASTE (registered trademark) CN-7120”) was attached to the inner peripheral surface of the conductive substrate. The first electrode was connected to a voltage applying device (Made by Trek “MODEL 677 B”). The second electrode and the ground were connected through an ammeter (Made by KEITHLEY “MODEL 485”). A voltage (+10 V) was applied to the first electrode using a voltage application device. The current value flowing between the first electrode and the second electrode 3 seconds after the voltage application was measured by using an ammeter. From the following expression (6), the volume resistivity ρ_{V} (unit: Ω·cm) of the undercoat layer was calculated. The volume resistivity of each undercoat layer is shown in Table 3 above.

Σ_{V}=R_{V}×(S/L)=(V/I)×(S/L) (6)

In expression (6), ρV represents the volume resistivity of the undercoat layer, R_{V} represents the resistance value of the undercoat layer, S represents the cross-sectional area of the undercoat layer, L represents the length of the undercoat layer, V represents the voltage applied between the first electrode and the second electrode, and I represents the measured current value. In this measurement, S was 0.238 cm² and L was 0.0002 cm.

<Measurement of the Charge Potential Difference of the Undercoat Layer>

As a sample for measuring the charging potential difference of the undercoat layer, the conductive substrate having the undercoat layer manufactured in the above [manufacture of the undercoat layer] was used. Note that this measurement sample did not have a photosensitive layer. A measurement sample was set in a drum sensitivity testing machine (manufactured by Gentec Corporation) equipped with a corotron charger.

Next, the first charging potential C_{HH} of the undercoat layer was measured when a current of +10 μA was passed in a HH environment having a temperature of 32.5° C. and a relative humidity of 80%. Specifically, the measurement sample was rotated at a speed of 150 rpm. During 20 rotations of the sample to be measured, the sample was charged continuously using a corotron charger such that the current value (Ipc) flowing through the undercoat layer was +10 μA. When the measurement sample was rotated 20 rotations, the charging potential of the undercoat layer was measured to be the first charging potential C_{HH}(units: +V).

Next, the second charging potential C_{LL} of the undercoat layer was measured when a current of +10 μA was passed in an LL environment having a temperature of 10.0° C. and a relative humidity of 15%. The second charging potential C_{LL}(units: +V) of the undercoat layer was measured by the same method as the measurement of the first charging potential C_{HH} except that the HH environment was changed to the LL environment.

From expression “Charged Potential Difference=|C_{HH}−C_{LL}|”, the charged potential difference (units: V) was calculated. The charging potential difference of each undercoat layer is shown in Table 3 above. In the measurement of the charge potential difference of the undercoat layer, exposure, development, transfer, and charge elimination were not performed.

[Manufacture of the Photoreceptor]

<Manufacture of Single-Layer Photoreceptors>

Single-Layer photoreceptors (A-1) to (A-5) and (B-1) to (B-4) according to Examples and Comparative Examples were prepared. The configurations of the single-layer photoreceptors (A-1) to (A-5) and (B-1) to (B-4) are shown in Table 4, which will be described later.

(Manufacture of Single-Layer Photoreceptors (A-1))

A coating liquid for a single-layer photosensitive layer was obtained by dispersing 2 parts by mass of Y-type titanyl phthalocyanine as a charge generating agent, 70 parts by mass of a hole transporting agent (H-1), 50 parts by mass of an electron transporting agent (E-1), and 100 parts by mass of a polyarylate resin (R-1) as a binder resin in 500 parts by mass of tetrahydrofuran as a solvent using a rod-like acoustic oscillator for 20 minutes. The resultant coating liquid for the single-layer photosensitive layer was filtered using a filter having a mesh size of 5 μm. A coating liquid for a single-layer photosensitive layer was applied to the undercoat layer manufactured in [manufacture of the undercoat layer] (UCL-1) by a dip coating method, and dried at 120° C. for 50 minutes. In this way, a single-layer photosensitive layer (UCL-1) was formed on the undercoat layer (film thickness of 33 μm), thereby obtaining a single-layer photoreceptor (A-1). In a single-layer photoreceptor (A-1), an undercoat layer (UCL-1) was provided on a conductive substrate, and a single-layer photosensitive layer was provided on the undercoat layer (UCL-1).

(Manufacture of single-layer photoreceptors (A-2) through (A-4)) Each of the single-layer photoreceptors (A-2) to (A-4) was manufactured in the same manner as the single-layer photoreceptors (A-1), except that the electron transporting agent (E-1) was changed to the electron transporting agent of the type shown in Table 4, and. The amount of the electron transporting agent added in the manufacture of these single-layer photoreceptors was the same as that of the single-layer photoreceptors (A-1), i.e., 50 parts by mass.

(Manufacture of Single-Layer Photoreceptors (A-5) and (B-1) to (B-4))

Except that the undercoat layer (-UCL-1) was changed to the undercoat layer shown in Table 4, each of the single-layer photoreceptor (A-5) and the (B-1) to (B-4) were manufactured by the same method as that of the single-layer photoreceptor (A-1). Each undercoat layer shown in Table 4 was manufactured in the above-mentioned [manufacture of the undercoat layer].

<Manufacture of Layered Photoreceptors>

Layered photoreceptors (C-1) to (C-5) and (D-1) to (D-4) according to Examples and Comparative Examples were manufactured. The configurations of the layered photoreceptors (C-1) to (C-5) and (D-1) to (D-4) are shown in Table 5, which will be described later.

(Manufacture of layered photoreceptors (C-1))

A charge generating layer was formed on the undercoat layer manufactured in [manufacture of the undercoat layer] (UCL-1). Specifically, 1.5 parts by mass of Y-type titanyl phthalocyanine as a charge generating agent, 1.0 parts by mass of polyvinyl acetal resin (made by Sekisui Chemical Co., Ltd. “Eslek KX-5”) as a base resin, 40.0 parts by mass of propylene glycol monomethyl ether, and 40.0 parts by mass of tetrahydrofuran were mixed using a bead mill for 6 hours to obtain a coating liquid for a charge generating layer. The charge generating layer coating liquid was filtered using a filter having a mesh size of 3 μm. The filtered charge generating layer coating liquid was applied onto the undercoat layer (UCL-1) by a dip coating method, and dried at 70° C. for 20 minutes. In this way, a charge generating layer (UCL-1) was formed on the undercoat layer (film thickness of 0.3 μm).

Next, a charge transport layer was formed. Specifically, 50 parts by mass of a hole transporting agent (H-1), 100 parts by mass of a polyarylate resin (R-1) which is a binder resin, 2 parts by mass of a hindered phenol antioxidant (made by BASF Corporation “Irganox (registered trademark) 1010”), 650 parts by mass of tetrahydrofuran, and 50 parts by mass of toluene were mixed using a roll mill for 12 hours to obtain a coating liquid for a charge transporting layer. The viscosity average molecular weight of the polyarylate resin (R-1) was 49600. The charge transport layer coating liquid was filtered using a 5 μm mesh filter. The charge transport layer coating liquid after filtration was applied to the charge generating layer by a dip coat method, and dried at 120° C. for 40 minutes. In this way, a charge transport layer (film thickness of 30 μm) was formed on the charge generating layer to obtain a layered photoreceptor (C-1). In the layered photoreceptor (C-1), an undercoat layer (UCL-1) is provided on a conductive substrate, a charge generating layer is provided on the undercoat layer (UCL-1), and a charge transport layer is provided on the charge generating layer.

(Manufacture of Layered Photoreceptors (C-2) to (C-4))

Except that the hole transporting agent (H-1) was changed to the hole transporting agent of the type shown in Table 5, each of the layered photoreceptors (C-2) to (C-4) was manufactured by the same method as that of the layered photoreceptors (C-1). It should be noted that the amount of the hole transporting agent added in the manufacture of these layered photoreceptors was the same as that of the layered photoreceptors (C-1), i.e., 50 parts by mass.

(Manufacture of Layered Photoreceptors (C-5) and (D-1) to (D-4))

Except that the undercoat layer (UCL-1) was changed to the undercoat layer shown in Table 5, each of the layered photoreceptors (C-5) and (D-1) to (D-4) were manufactured in the same manner as the layered photoreceptor (C-1). Each undercoat layer shown in Table 5 was manufactured in the above-mentioned [manufacture of the undercoat layer].

[Evaluation method]

<Evaluation of Sensitivity Characteristics of Single-Layer Photoreceptor>

First, the post-exposure potential of the single-layer photoreceptor was measured in a HH environment at a temperature of 32.5° C. and a relative humidity of 80%. Specifically, using a drum sensitivity testing machine (Manufactured by Gentec Corporation), the surface of the single-layer photoreceptor was charged to +750 V. The monochromatic light (wavelength: 780 nm, exposure: 0.070 μJ/cm²) was then extracted from the light of the halogen lamp using a bandpass filter, and then the surface of the single-layer photoreceptor was irradiated using the light. The surface potential of a single-layer photoreceptor was measured 50 ms after the end of monochromatic light irradiation. The measured surface potential was defined as the post-exposure potential (units: +V) of the single-layer photoreceptor under the HH environment. The post-exposure potential of the single-layer photoreceptor in the HH environment is shown in the “HH sensitivity” column of Table 4.

Next, the post-exposure potential of the single-layer photoreceptor was measured in an LL environment at a temperature of 10.0° C. and a relative humidity of 15%. The post-exposure potential (units: +V) of the single-layer photoreceptor under the LL environment was measured by the same method as the post-exposure potential measurement of the single-layer photoreceptor under the HH environment except that the HH environment was changed to the LL environment. The post-exposure potential of the single-layer photoreceptor in the LL environment is shown in the “LL Sensitivity” column of Table 4.

Next, from the expression “(LL-HH sensitivity difference)=(Post-Exposure potential of a single-layer photoreceptor in an LL environment)−(Post-Exposure potential of a single-layer photoreceptor in a HH environment)”, the LL-HH sensitivity difference (units: +V) of the single-layer photoreceptor was calculated. The LL-HH sensitivity difference of the single-layer photoreceptor is shown in the column “LL-HH sensitivity difference” of Table 4. The smaller the absolute value of the LL-HH sensitivity difference is, the smaller the fluctuation of the sensitivity characteristic of the single-layer photoreceptor due to humidity is.

<Evaluation of Sensitivity Characteristics of Layered Photoreceptor>

First, the post-exposure potential of the layered photoreceptor was measured in an HH environment at a temperature of 32.5° C. and a relative humidity of 80%. Specifically, a drum sensitivity testing machine (Manufactured by Gentec Corporation) was used to charge the surface of the layered photoreceptor to −700 V. Then, monochromatic light (wavelength: 780 nm, exposure: 1.00 μJ/cm²) was taken out from the light of the halogen lamp using a bandpass filter, and the surface of the layered photoreceptor was irradiated with the monochromatic light. The surface potential of the layered photoreceptor was measured 50 ms after the end of monochromatic light irradiation. The measured surface potential was defined as the post-exposure potential (units: −V) of the layered photoreceptor under the HH environment. The post-exposure potential of the layered photoreceptor in the HH environment is shown in the “HH sensitivity” column of Table 5.

Next, the post-exposure potential of the layered photoreceptor was measured in an LL environment at a temperature of 10.0° C. and a relative humidity of 15%. The post-exposure potential (units: −V) of the layered photoreceptor under the LL environment was measured by the same method as the post-exposure potential measurement of the layered photoreceptor under the HH environment except that the HH environment was changed to the LL environment. The post-exposure potential of the layered photoreceptor in the LL environment is shown in the “LL Sensitivity” column of Table 5.

Next, from the expression “(LL-HH sensitivity difference)=(Post-Exposure potential of layered photoreceptor under LL environment)−(Post-Exposure potential of layered photoreceptor under HH environment)”, the LL-HH sensitivity difference (Units: −V) of the layered photoreceptor was calculated. The LL-HH sensitivity difference of the layered photoreceptor is shown in the column of “LL-HH sensitivity difference” in Table 5. The smaller the absolute value of the LL-HH sensitivity difference, the smaller the fluctuation of the sensitivity characteristic of the layered photoreceptor due to humidity.

<Evaluation of Pressure Resistance of Single-Layer Photoreceptor>

The pressure resistance of the single-layer photoreceptor was evaluated at a temperature of 23° C. and a relative humidity of 50%. For the evaluation of the pressure resistance, a pressure resistance tester (Prototype manufactured by Kyocera Document Solutions) equipped with a needle electrode was used. First, the tip of the needle electrode was brought close to the surface of the single-layer photoreceptor so that the axial direction of the needle electrode and the rotational axial direction of the single-layer photoreceptor are orthogonal to each other. The distance between the surface of the single-layer photoreceptor and the tip of the needle electrode was 1 mm. The voltage applied to the needle electrode was increased under the conditions of a start voltage of 0 V and a step-up speed of +300 V/sec. Then, the voltage (Unit: +kV) at the time when the leakage occurred in the single-layer photoreceptor was measured. The measurement results are shown in Table 4 in the “pressure resistance” column. The larger the absolute value of the voltage at the time of occurrence of the leak, the higher the pressure resistance of the single-layer photoreceptor.

<Evaluation of Pressure Resistance of Layered Photoreceptor>

The pressure resistance of the layered photoreceptor was evaluated under an environment of a temperature of 23° C. and a relative humidity of 50%. For the evaluation of the pressure resistance, a pressure resistance tester (Prototype manufactured by Kyocera Document Solutions) equipped with a needle electrode was used. First, the tip of the needle electrode was brought close to the surface of the layered photoreceptor so that the axial direction of the needle electrode and the rotational axial direction of the layered photoreceptor are orthogonal to each other. The distance between the surface of the layered photoreceptor and the tip of the needle electrode was 1 mm. The voltage applied to the needle electrode was lowered under the conditions of a start voltage of 0 V and a step-down speed of −300 V/sec. Then, the voltage (Unit: −kV) at the time when the leakage occurred in the layered photoreceptor was measured. The measurement results are shown in Table 5 in the “pressure resistance” column. The larger the absolute value of the voltage at the time when the leakage occurs, the higher the pressure resistance of the layered photoreceptor.

The meanings of the terms in Tables 4 and 5 are as follows. “HTM” represents a hole transporting agent, “ETM” represents an electron transporting agent, and “resin” represents a polyarylate resin. The hole-transporting agents (H-1) to (H-4), the electron-transporting agents (E-1) to (E-4), and the polyarylate resin (R-1) were described in Embodiment 3. In the “LL Sensitivity” column, the post-exposure potential under the LL environment is described. In the “HH sensitivity” column, the post-exposure potential in the HH environment is described. In the “pressure resistance” column, the voltage at the time when a leak occurs in the photoreceptor is indicated.

TABLE 4

| | | | | | | Evaluation | | | |
|---|---|---|---|---|---|---|---|---|---|
| | | | | | | | | LL − HH | |
| | | | Single-layer | | | LL | HH | sensitivity | Pressure |
| | Single-layer | Undercoat | photosensitive layer | | | sensitivity | sensitivity | difference | resistance |
| | photoreceptor | layer | HTM | ETM | Resin | [+V] | [+V] | [+V] | [+kV] |
| Example 3 | A-1 | UCL-1 | H-1 | E-1 | R-1 | 141 | 116 | 25 | 8.8 |
| Example 4 | A-2 | UCL-1 | H-1 | E-2 | R-1 | 151 | 126 | 25 | 8.4 |
| Example 5 | A-3 | UCL-1 | H-1 | E-3 | R-1 | 152 | 128 | 24 | 8.6 |
| Example 6 | A-4 | UCL-1 | H-1 | E-4 | R-1 | 142 | 119 | 23 | 8.4 |
| Example 7 | A-5 | UCL-2 | H-1 | E-1 | R-1 | 151 | 121 | 30 | 9.1 |
| Comparative | B-1 | UCL-3 | H-1 | E-1 | R-1 | 161 | 120 | 41 | 8.9 |
| example 5 | | | | | | | | | |
| Comparative | B-2 | UCL-4 | H-1 | E-1 | R-1 | 181 | 123 | 58 | 8.8 |
| example 6 | | | | | | | | | |
| Comparative | B-3 | UCL-5 | H-1 | E-1 | R-1 | 138 | 116 | 22 | 7.9 |
| example 7 | | | | | | | | | |
| Comparative | B-4 | UCL-6 | H-1 | E-1 | R-1 | 160 | 125 | 35 | 8.8 |
| example 8 | | | | | | | | | |

TABLE 5

| | | | | | Evaluation | | | |
|---|---|---|---|---|---|---|---|---|
| | | | Layered | | | | LL − HH | |
| | | | photosensitive | | LL | HH | sensitivity | Pressure |
| | Layered | Undercoat | layer | | sensitivity | sensitivity | difference | resistance |
| | photoreceptor | layer | HTM | Resin | [−V] | [−V] | [−V] | [−kV] |
| Example 8 | C-1 | UCL-1 | H-1 | R-1 | 88 | 52 | 36 | 9.0 |
| Example 9 | C-2 | UCL-1 | H-2 | R-1 | 106 | 67 | 39 | 8.9 |
| Example 10 | C-3 | UCL-1 | H-3 | R-1 | 104 | 65 | 39 | 8.8 |
| Example 11 | C-4 | UCL-1 | H-4 | R-1 | 112 | 78 | 34 | 9.4 |
| Example 12 | C-5 | UCL-2 | H-2 | R-1 | 92 | 53 | 39 | 9.4 |
| Comparative | D-1 | UCL-3 | H-2 | R-1 | 108 | 55 | 53 | 9.0 |
| example 9 | | | | | | | | |
| Comparative | D-2 | UCL-4 | H-2 | R-1 | 116 | 54 | 62 | 9.0 |
| example 10 | | | | | | | | |
| Comparative | D-3 | UCL-5 | H-2 | R-1 | 85 | 52 | 33 | 8.0 |
| example 11 | | | | | | | | |
| Comparative | D-4 | UCL-6 | H-2 | R-1 | 102 | 58 | 44 | 8.9 |
| example 12 | | | | | | | | |

As shown in Table 3, each of the undercoat layers (UCL-1) and (UCL-2) contained metal particles and polyamide resin. The metal particles had a core containing titanium oxide and a coat layer containing a metal oxide (Specifically, alumina) different from titanium oxide. Alumina was located on the top surface of the metal particles. The absorption rate of the polyamide resin was ≥0.70.

Therefore, as shown in Table 4, the absolute value of the LL-HH sensitivity difference of the single-layer photoreceptors (A-1) to (A-5) having the undercoat layer (UCL-1) or (UCL-2) was 30 V or less. Therefore, the single-layer photoreceptors (A-1) to (A-5) have suppressed the fluctuation of sensitivity characteristics due to humidity as compared with the single-layer photoreceptors (B-1), (B-2), and (B-4). The absolute value of the voltage when the leakage occurred in the single-layer photoreceptors (A-1) to (A-5) having the undercoat layer (UCL-1) or (UCL-2) was 8.4 V or more. Therefore, the single-layer photoreceptors (A-1) to (A-5) were superior to the single-layer photoreceptors (B-3) in pressure resistance.

As shown in Table 5, the absolute value of the LL-HH sensitivity difference of the layered photoreceptors (C-1) to (C-5) having the undercoat layer (UCL-1) or (UCL-2) was 39 V or less. Therefore, the layered photoreceptors (C-1) to (C-5) have a lower fluctuation in sensitivity characteristics due to humidity than the layered photoreceptors (D-1), (D-2), and (D-4). The absolute value of the voltage when leakage occurred in the layered photoreceptors (C-1) to (C-5) having the undercoat layer (UCL-1) or (UCL-1) was 8.8 V or more. Therefore, the layered photoreceptors (C-1) to (C-5) were superior to the layered photoreceptors (D-3) in pressure resistance.

From the above, it is judged that the undercoat layer of the present disclosure and the undercoat layer manufactured by the manufacturing method of the present disclosure can improve the pressure resistance of the photoreceptor and suppress the fluctuation of the sensitivity characteristic of the photoreceptor due to humidity when provided in the photoreceptor. Further, it is judged that the photoreceptor and the image forming apparatus of the present disclosure have excellent pressure resistance and can suppress the fluctuation of sensitivity characteristics due to humidity.

### INDUSTRIAL APPLICABILITY

The undercoat layer according to the present disclosure and the undercoat layer manufactured by the manufacturing method according to the present disclosure can be used for a photoreceptor. The photoreceptor according to the present disclosure can be used in an image forming apparatus. The image forming apparatus according to the present disclosure can be used for forming an image on a recording medium.

The present disclosure is applicable to an image forming apparatus for forming an image by filling a plurality of developing devices with the same color and the same type of toner. With the use of the present disclosure, it is possible to provide an image forming apparatus capable of easily and accurately detecting an image forming portion in which an abnormality occurs, and capable of effectively suppressing the occurrence of an image defect.

What is claimed is:

1. The undercoat layer comprising:
metal particles and a polyamide resin,
wherein the metal particles include a core and a coat layer covering at least a part of a surface of the core;
wherein the core includes titanium oxide,
wherein the coat layer includes at least a metal oxide different from the titanium oxide;
wherein the metal oxide different from the titanium oxide is located on the outermost surface of the metal particles,
wherein the polyamide resin includes an amide bond and an alkylene group, and
wherein an absorption rate of a second absorbance of a second peak derived from the alkylene group to a first absorbance of a first peak derived from the amide bond measured by infrared spectroscopy being not less than 0.70,
the first peak being the maximum peak in a wave number range of 1620 cm⁻¹ to 1680 cm⁻¹, and
the second peak being a maximum peak in a wave number range of 2900 cm⁻¹ to 2970 cm⁻¹.

2. The undercoat layer of claim 1, wherein the metal oxide different from the titanium oxide is alumina.

3. The undercoat layer of claim 2, wherein the coat layer further comprises silica.

4. The undercoat layer of claim 2, wherein the coat layer does not contain a polymer having a siloxane bond.

5. The undercoat layer according to claim 1, wherein the volume resistivity of the undercoat layer is 1.0×10¹⁰ Ω·cm or more.

6. The undercoat layer according to claim 1,
wherein the polyamide resin has a water absorption rate of 3.0 mass % or less.

7. The undercoat layer according to claim 1,
wherein the first charging potential C_{HH} of the undercoat layer when a current of +10 μA flows in a first environment at a temperature of 32.5° C. and a relative humidity of 80%, and the second charging potential C_{LL} of the undercoat layer when a current of +10 μA flows in a second environment at a temperature of 10.0° C. and a relative humidity of 15%, satisfy the following formula (1)

|C_{HH}−C_{LL}|≤10 V (1)

8. The undercoat layer according to claim 1, wherein a content of the metal particles is 2.0 parts by mass or more with respect to 1.0 parts by mass or more of the polyamide resin.

9. A method for manufacturing an undercoat layer, comprising:
an undercoat layer forming step wherein a coating liquid containing metal particles, a polyamide resin, and a solvent is applied to an object to be coated and dried to form the undercoat layer according to claim 1,
wherein the solvent contains methanol, butanol and toluene.
Wherein a percentage M_{M} of the mass of the methanol, a percentage M_{B} of the mass of the butanol, and a percentage M_{T} of the mass of toluene, to the mass of the solvent, satisfy the following formulae (2), (3), (4) and (5).
M_{M}+M_{B}+M_{T}=100 (2)
30≤M_{M}≤90 (3)
5<M_{B}<50 (4)
5≤M_{T}≤50 (5)

10. An electrophotographic photoreceptor according to claim 1, comprising:
a conductive substrate;
a photosensitive layer containing a charge generating agent; and
an undercoat layer provided between the conductive substrate and the photosensitive layer,
wherein the undercoat layer is the undercoat layer according to claim 1.

11. The electrophotographic photoreceptor according to claim 10,
wherein the photosensitive layer contains a binder resin,
wherein the binder resin contains a polyarylate resin,
wherein the polyarylate resin comprises at least one type of a repeating unit represented by general formula (10) and at least one type of a repeating unit represented by general formula (11) 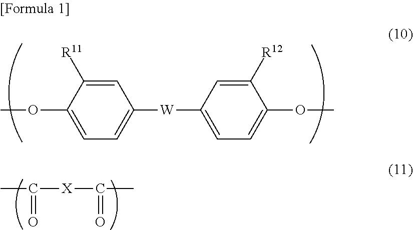
(in formula (10), R¹¹ and R¹² each independently represent a hydrogen atom or a methyl group, W represents a divalent group represented by general formula (W1), general formula (W2) or chemical formula (W3),
in the general formula (11), X represents a divalent group represented by chemical formula (X1), chemical formula (X2), or chemical formula (X3)) 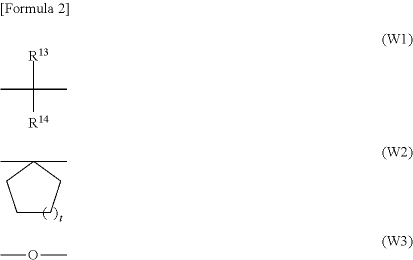
(in the general formula (W1), R¹³ represents a hydrogen atom or an alkyl group having 1 to 4 carbon atoms, and R¹⁴ represents an alkyl group having 1 to 4 carbon atoms;
in the general formula (W2), t represents an integer of 1 to 3, inclusive).

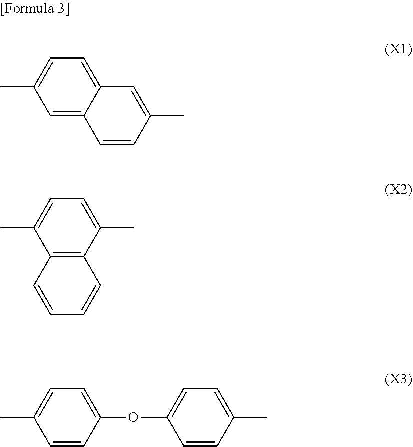

12. The electrophotographic photoreceptor of claim 11,
wherein the polyarylate resin comprises repeating units represented by chemical formulae (10-2), (11-X1), and (11-X3).

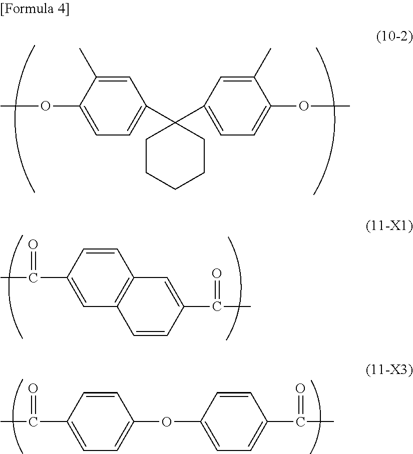

13. The electrophotographic photoreceptor of claim 10,
wherein the photosensitive layer contains an electron transporting agent, and
wherein the electron transporting agent comprises a compound of the general formula (20), (21), (22) or (23). 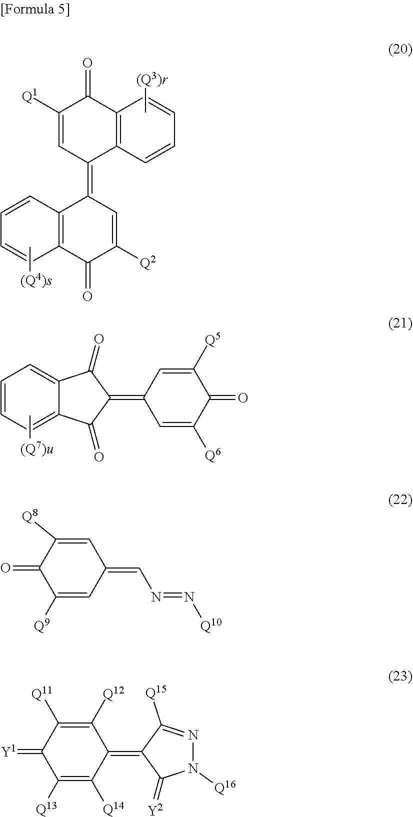
(in the general formula (20), Q¹ and Q² each independently represent a hydrogen atom, an alkyl group having 1 to 8 carbon atoms, a phenyl group, or an alkoxy group having 1 to 8 carbon atoms, Q³ and Q⁴ each independently represent an alkyl group having 1 to 8 carbon atoms, a phenyl group, or an alkoxy group having 1 to 8 carbon atoms, and r and s each independently represent an integer of 0 to 4, inclusive,
in the general formula (21), Q⁵ and Q⁶ each independently represent a hydrogen atom, an alkyl group having 1 to 8 carbon atoms, a phenyl group, or an alkoxy group having 1 to 8 carbon atoms, Q⁷ represents an alkyl group having 1 to 8 carbon atoms, a phenyl group, or an alkoxy group having 1 to 8 carbon atoms, and u represents an integer of 0 to 4, inclusive,
in the general formula (22), Q⁸ and Q⁹ each independently represent a hydrogen atom or an alkyl group having 1 to 6 carbon atoms, and Q¹⁰ represents an aryl group having 6 to 14 carbon atoms which may be substituted with a halogen atom,
in the general formula (23), Q¹¹, Q¹², Q¹³, Q¹⁴, Q¹⁵, and Q¹⁶ each independently represents a hydrogen atom, an alkyl group having 1 to 6 carbon atoms, or an aryl group having 6 to 14 carbon atoms, Y¹ represents an oxygen atom, a sulfur atom, or ═C(CN)², and Y² represents an oxygen atom or a sulfur atom).

14. The electrophotographic photoreceptor of claim 13,
wherein the compound represented by the general formula (20) is a compound represented by the chemical formula (E-1),
wherein the compound represented by the general formula (21) is a compound represented by the chemical formula (E-3),
wherein the compound represented by the general formula (22) is a compound represented by the chemical formula (E-2), and
wherein the compound represented by general formula (23) is a compound represented by chemical formula (E-4).

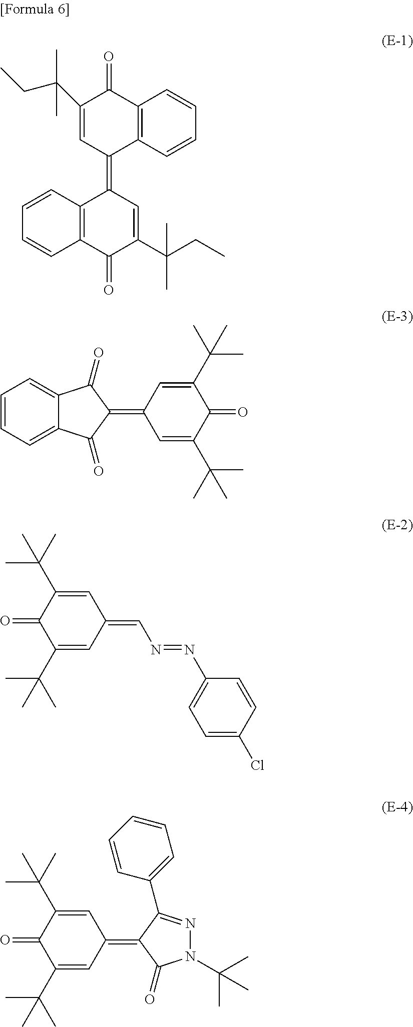

15. The electrophotographic photoreceptor of claim 10,
wherein the photosensitive layer contains a hole transporting agent, and
wherein the hole transporting agent comprises a compound represented by general formula (30), (31) or (32). 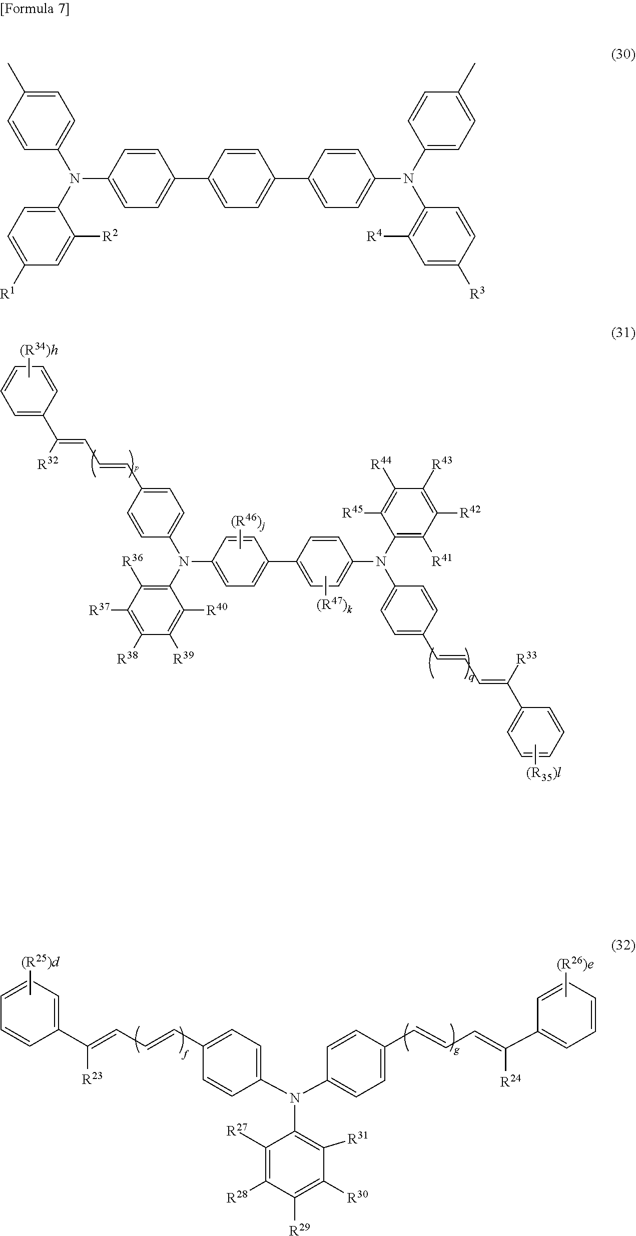
(in the formula (30), R¹ and R² each independently represent a hydrogen atom, a methyl group, or an ethyl group, the sum of the number of carbon atoms of the group represented by R¹ and the number of carbon atoms of the group represented by R² is 2, R³ and R⁴ each independently represent a hydrogen atom, a methyl group, or an ethyl group, and the sum of the number of carbon atoms of the group represented by R³ and the number of carbon atoms of the group represented by R⁴ is 2,
in the general formula (31), R³² and R³³ each independently represents a hydrogen atom, an alkyl group having 1 to 8 carbon atoms, or a phenyl group, R³⁴, R³⁵, R⁴⁶, and R⁴⁷ each independently represent an alkyl group or a phenyl group having 1 to 8 carbon atoms; R³⁶ to R⁴⁵ each independently represent a hydrogen atom, an alkyl group having 1 to 8 carbon atoms, or a phenyl group, p and q each independently represent 0 or 1, h and i independently represent an integer of 0 to 5, inclusive, and j and k independently represent an integer of 0 to 4, inclusive,
in the general formula (32), R²³ and R²⁴ each independently represent a hydrogen atom, an alkyl group having 1 to 8 carbon atoms, an alkoxy group having 1 to 8 carbon atoms, or a phenyl group which may be substituted with an alkyl group having 1 to 8 carbon atoms, R²⁵ and R²⁶ each independently represent an alkyl group having 1 to 8 carbon atoms, an alkoxy group having 1 to 8 carbon atoms, or a phenyl group, R²⁷, R²⁸, R²⁹, R³⁰, and R³¹ each independently represents a hydrogen atom, an alkyl group having 1 to 8 carbon atoms, an alkoxy group having 1 to 8 carbon atoms, or a phenyl group, and adjacent 2 of R²⁷, R²⁸, R²⁹, R³⁰, and R³¹ may bond to each other to represent a ring, d and e each independently represent an integer of 0 to 5, inclusive, and f and g each independently represent 1 or 2).

16. The electrophotographic photoreceptor of claim 15,
wherein the compound represented by the general formula (30) is a compound represented by the chemical formula (H-1),
wherein the compound represented by the general formula (31) is a compound represented by the chemical formula (H-2) or (H-3), and
wherein the compound represented by general formula (32) is a compound represented by chemical formula (H-4).

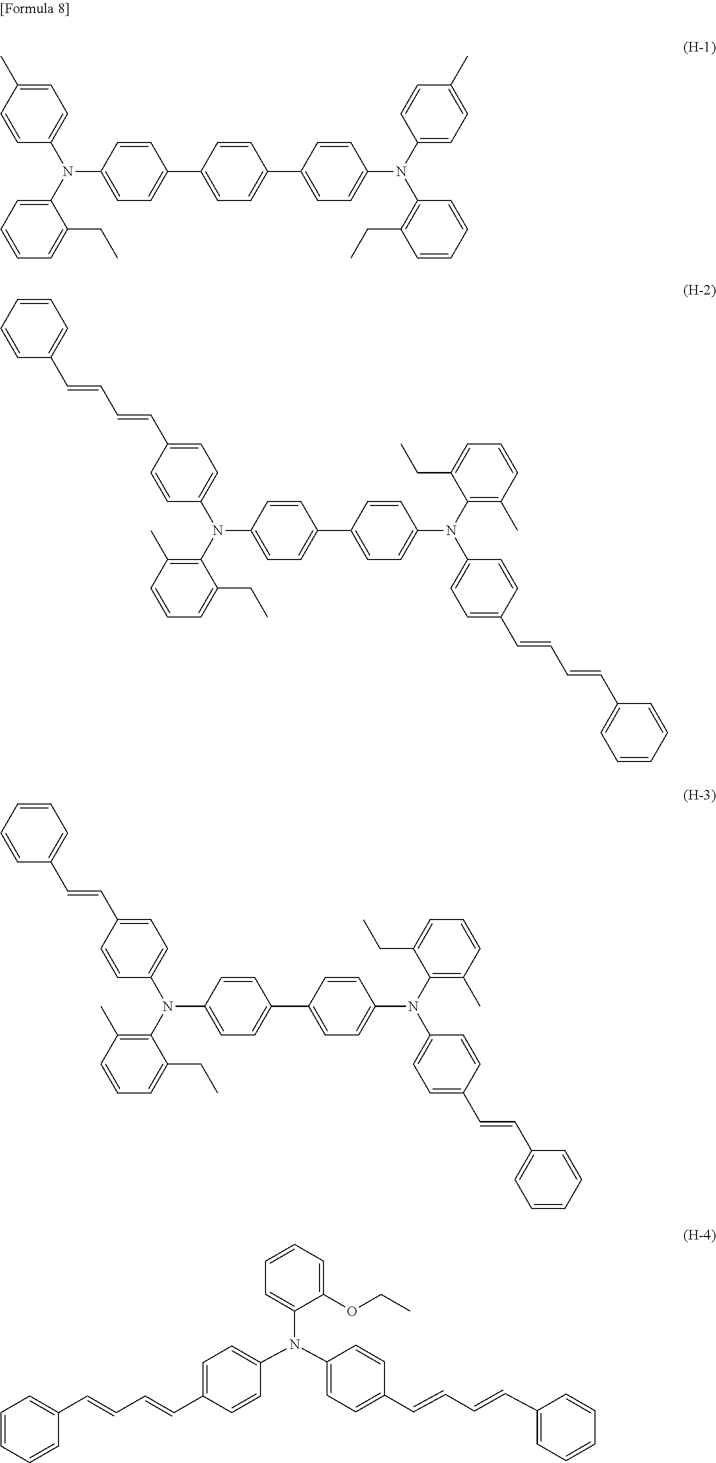

17. An image forming apparatus comprising:
an electrophotographic photoreceptor;
a charging device for charging a surface of the electrophotographic photoreceptor;
an exposure apparatus for exposing the charged surface of the electrophotographic photoreceptor to form an electrostatic latent image on the surface of the electrophotographic photoreceptor;
a developing device for developing the electrostatic latent image as a toner image; and
a transfer device for transferring the toner image from the electrophotographic photoreceptor to the object to be transferred,
wherein the electrophotographic photoreceptor includes:
a conductive substrate;
a photosensitive layer containing a charge generating agent; and
an undercoat layer provided between the conductive substrate and the photosensitive layer,
wherein the undercoat layer is the undercoat layer according to claim 1.

18. The image forming apparatus according to claim 17,
wherein the object to be transferred is a recording medium,
wherein the transfer device transfers the toner image from the electrophotographic photoreceptor to the recording medium while the surface of the electrophotographic photoreceptor is in contact with the recording medium.

19. The image forming apparatus according to claim 17,
wherein the developing device is in contact with the surface of the electrophotographic photoreceptor.

20. The image forming apparatus according to claim 17
wherein the charging device is a charging roller.

21. The image forming apparatus of claim 17, further comprising:
a cleaning roller for polishing the surface of the electrophotographic photoreceptor to recover toner adhering to the surface of the electrophotographic photoreceptor.
